(19) United States
(12) Patent Application Publication
(10) Pub. No.: US 2022/0241985 A1
(43) Pub. Date: Aug. 4, 2022

(54) SYSTEMS AND METHODS TO MANAGE CONVERSATION INTERACTIONS BETWEEN A USER AND A ROBOT COMPUTING DEVICE OR CONVERSATION AGENT

(71) Applicant: Embodied, Inc., Pasadena, CA (US)

(72) Inventors: Stefan A. Scherer, Santa Monica, CA (US); Mario E Munich, La Canada, CA (US); Paolo Pirjanian, Glendale, CA (US); Caitlyn Clabaugh, Los Angeles, CA (US); Wilson Harron, Los Angeles, CA (US); Asim Naseer, Diamond Bar, CA (US); Albert Ike Macoco, Jr., Woodland Hills, CA (US)

(21) Appl. No.: 17/614,315

(22) PCT Filed: Feb. 26, 2021
(86) PCT No.: PCT/US2021/020035

§ 371 Date: Nov. 24, 2021

Related U.S. Application Data
(60) Provisional application No. 62/983,590, filed on Feb. 29, 2020.
(60) Provisional application No. 63/153,888, filed on Feb. 25, 2021.

(51) Int. Cl. B25J 11/00; B25J 13/00; B25J 19/02; G06V 40/16; G06V 40/20; G10L 15/18; G10L 15/22; G10L 25/63; G10L 25/90

(52) U.S. Cl. CPC B25J 11/0015; B25J 11/001; B25J 13/003; B25J 19/023; G06V 40/174; G10L 2015/227; G10L 15/1815; G10L 15/22; G10L 25/63; G10L 25/90; G06V 40/20

(57) ABSTRACT

Exemplary implementations may: receive one or more inputs including parameters or measurements regarding a physical environment from the one or more input modalities; identify a user based on analyzing the received inputs from the one or more input modalities; determine if the user shows signs of engagement or interest in establishing a communication interaction by analyzing a user's physical actions, visual actions, and/or audio actions, the user's physical actions, visual actions and/or audio actions determined based at least in part on the one or more inputs received from the one or more input modalities; and determine whether the user is interested in an extended communication interaction with the robot computing device by creating visual actions of the robot computing device utilizing the display device or by generating one or more audio files to be reproduced by one or more speakers.

### CROSS-REFERENCE TO RELATED APPLICATIONS

The present application claims priority to U.S. provisional patent application Ser. No. 62/983,590, filed Feb. 29, 2020, entitled “Systems And Methods To Manage Conversation Interactions Between A User And A Robot Computing Device Or Conversation Agent,” and to U.S. provisional patent application Ser. No. 63/153,888, filed Feb. 25, 2021, entitled “Systems And Methods To Manage Conversation Interactions Between A User And A Robot Computing Device Or Conversation Agent,” the contents of which are both incorporated herein by reference in their entirety.

### FIELD OF THE DISCLOSURE

The present disclosure relates to systems and methods to manage communication interactions between a user and a robot computing device.

### BACKGROUND

Successful human to human communication is much like a dance, a constant but coordinated back and forth between interlocutors. Turn-taking and switching the floor between human interlocutors is seamless and works without explicit signals, such as telling the other to speak or giving a gesture signaling that a speaker yields the floor. It comes naturally to humans to understand if someone is engaged in a conversation or not. All these skills may further scale to multiparty interactions as well.

In contrast, human-machine interaction currently is very cumbersome and asymmetric requiring the human user to explicitly use a so-called wakeword or hot-word (“Alexa”, “Hey, Siri”, “OK, Google”, etc.) to initiate a conversation transaction and provide an explicit often learned command or phrasing to render a successful result. Interactions only function in a single-transactional fashion (i.e., the human user has an explicit request and the agent provides a single response). Therefore, multiturn interactions are rare and do not go beyond direct requests to gather information or reduce ambiguity (e.g., User: “Alexa, I want to make a reservation.”, Alexa: “Ok, which restaurant?”, User: “Tar and Roses in Santa Monica”). Current conversational agents are also fully reactive and do not proactively engage or reengage the user after they have lost interest in the interaction. Further, state-of-the-art conversational agents rarely use multimodal inputs to better understand or disambiguate the user's intent, current state, or message. Accordingly, a need exists for conversation agents or modules that analyze multimodal input and provide more human-like conversation interaction.

### SUMMARY

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1A illustrates a system for a social robot or digital companion to engage a child and/or a parent, in accordance with one or more implementations.

FIG. 1B illustrates module or subsystems in a system where a child engages with a social robot or digital companion, in accordance with one or more implementations.

FIG. 1C illustrates modules or subsystems in a system where a child engages with a social robot or digital companion, in accordance with one or more implementations.

FIG. 2 illustrates a system architecture of an exemplary robot computing device, according to some implementations.

FIG. 3 illustrates a computing device or robot computing device configured to manage communication interactions between a user and a robot computing device, in accordance with one or more implementations.

FIG. 4A illustrates a method to manage communication interactions between a user and a robot computing device, in accordance with one or more implementations.

FIG. 4B illustrates a method to extend communication interactions between a user and a robot computing device according to one or more implementations.

FIG. 4C illustrates a method of reengaging a user who is showing signs of disengagement in a conversation interaction according to one or more implementations.

FIG. 4D illustrates a method of utilizing past parameters and measurements from a memory device or the robot computing device to assist in a current conversation interaction according to one or more implementations.

FIG. 4E illustrates measuring and storing a length of a conversation interaction according to one or more implementations.

FIG. 4F illustrates determining engagement levels in conversation interactions with multiple users according to some one or more implementations.

FIG. 5 illustrates a block diagram of a conversation between a robot computing device and/or a human user, in accordance with one or more implementations.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

In current conversational agents or modules, most of the multimodal information is discarded and ignored. However, in the subject matter described below, the multimodal information may be leveraged to better understand and disambiguate the meaning or intention. For example, a system trying to react to the spoken phrase “go get me that from over there” without leveraging the user's gestures (i.e., pointing in a specific direction) is unable to react without following up on the request. For example, an elongated spoken “yeah” accompanied with furrowed eyebrows, which is often associated with doubt or confusion, carries a significantly different meaning than a shorter spoken “yeah” accompanied with a head nod, which is usually associated with positive and agreeable feedback. Further, the prosody and intonation of spoken words, facial expressions, or posture may be used to understand the sentiment or affect of a message when the contents of spoken words alone are not enough to understand the full context. In addition, multimodal input from imaging devices and/or one or more voice input devices (such as microphones) may be utilized to manage conversation turn-taking behavior. Examples of such multimodal input include a human user's gaze, a human's orientation with respect to the robot computing device, tone of voice, and/or speech may be utilized to manage turn-taking behavior. As an example, in some implementations, a pause accompanied with eye contact clearly signals the intention to yield the floor, while a pause with averted eye gaze is a strong signal of active thinking and of the intention to maintain the floor.

On the output side, current artificial conversational agents predominantly use speech as their only output modality. The current artificial conversational agents do not augment the conveyed spoken message. In addition, current conversational agents do not try to manage the flow of the conversation interaction and their output, by using additional multimodal information from imaging devices and/or microphones and associated software. In other words, the current conversation agents do not capture and/or use facial expressions, voice inflection, visual aids (like overlays, gestures, or other outputs) to augment their output. The lack of utilizing this information leads to largely dull conversation interactions that are characterized by short turns (the user or agent cannot maintain the floor for more than a single speech volley) and long pauses (to ensure that the conversation agent doesn't interrupt a user's speech turn), and/or that conversation agents err on the side of caution when responding).

Further, current conversation agents or software largely ignore a possibility of multi-user scenarios and treats every user as if they were interacting with a robot computing device or digital companion by themselves. The management of turn-taking dynamics in multi-party conversations (e.g., >2 users and a computing device or artificial companion) is impossible unless multimodal input is received and/or utilized. Accordingly, the claimed subject matter addresses that it is important for a conversation agent to maintain knowledge of the current state of the world or environment the user is in, to track user locations and/or to identify which user is engaged with the robot computing device or digital companion and which user may just be a passerby (and thus not interested in a conversation interaction).

In order for a robot computing device or digital companion to form long-term relationships with human users, it is essential that conversational agents in the robot computing device or artificial companion to recognize human users and remember past conversations they had with the human users. Current conversation agents largely treat every transaction as if it were independent. No information, parameters or measurements are stored in a memory device and/or are maintained beyond the present communication transaction or between encounters. This lack of use of past data, measurements and/or parameters limits the depth or type of conversations that are possible between the human user and the conversation agent in the robot computing device or digital companion. In particular, it is difficult for the user to establish core requirements for long-term relationships such as rapport and trust with the robot computing device or digital companion without knowledge of past conversations as well as having in depth and/or complex communications. Thus, the systems and methods described herein store parameters and measurements from past conversation in one or more memory devices to help the user establish rapport and trust.

In some implementations of the claimed subject matter, Embodied's conversational agents or modules, by incorporating multimodal information, build an accurate representation of a physical world or environment around them and track updates of this physical world or environment over time. In some implementations, this may be generated by a world map module. In some implementations of the claimed subject matter, Embodied's conversation agents or modules may leverage identification algorithms or processes to identify and/or recall users in the environment. In some implementations of the claimed subject matter, Embodied's conversation agents or modules, when users in the environment, show signs of engagement and interest, the conversation agent may proactively engage the user utilizing eye gazes, gestures, and/or verbal utterances to probe to see if the users are willing to connect and engage in a conversation interaction with the user.

In some implementations of the claimed subject matter, Embodied's conversation agent or module may, if a user is engaged with the robot computing device and conversational agent, analyze a user's behavior by assessing linguistic context, facial expression, posture, gestures, and/or voice inflection to better understand the intent and meaning of the conversation interaction. In some implementations, the conversation agent or module may help a robot computing device determine when to take a conversation turn. In some implementations of the claimed subject matter, the conversation agent may analyze the user's multimodal natural behavior (e.g., speech, gestures, facial expressions) to identify when it is the robot computing device's turn to take the floor. In some implementations of the claimed subject matter, the Embodied conversation agent or module may respond to the user's multimodal expressions, voice and/or signals (facial expressions, spoken words, gestures) as indicators as to when it is time for the human user to respond and then the Embodied conversation agent or module may yield the conversation turn. In some implementations of the claimed subject matter, if a user shows signs of disengagement, the Embodied conversation agent, engine or module may attempt to re-engage the user by proactively seeking their attention by generating one or more multimodal outputs that may get the user's attention.

In some implementations of the claimed subject matter, the conversation agent or module may leverage a robotic computing device or digital companion's conversational memory to refer to past experiences and interactions to form a bond or trust with the user. In some implementations, these may include parameters or measurements that are associated or correspond to past conversation interaction between the user and robot computing device. In some implementations of the claimed subject matter, Embodied's conversation agent or module may use past experiences or interactions that were successful with a user (and associated parameters or measurements) and select such conversation interactions as models or preferred implementations over other communication interactions that would likely yield less successful outcomes. In some implementations of the claimed subject matter, Embodied's conversation agent may further extend these skills of conversation management and recognition of engagement to multiparty interactions (where there are more than one potential users in an environment). In some implementations, Embodied's conversation agent or system may recognize a primary user by comparing parameters and measurements of the primary user and may be able to prioritize the primary user over other users. In some cases, this may utilize facial recognition to recognize the primary user. In some implementations, the conversation agent or system may compare parameters or measurements of a user with the stored parameters or measurements of the primary user to see if there is a match. In some implementations of the claimed subject matter, Embodied's conversation agent or module may be focused on longer or more extended conversation interactions. In prior devices, one of the core metrics of prior conversational agents has been to focus on a reduction in turns between the human user and the conversation agent (the thinking being that the shorter the communication interaction the better). However, the Embodied conversation agent or module described herein is focused on lengthening extended conversation interactions because shorter communications can lead to abnormal communication modeling in children and is counterproductive.

Although the term “robot computing device” is utilized, the teachings and disclosure herein apply also to digital companions, computing devices including voice recognition software and/or computing devices including facial recognition software. In some cases, these terms are utilized interchangeably. Further, the specification and/or claims may utilize the term conversation agent, conversation engine and/or conversation module interchangeably, where these refer to software and/or hardware that performs the functions of conversation interactions described herein.

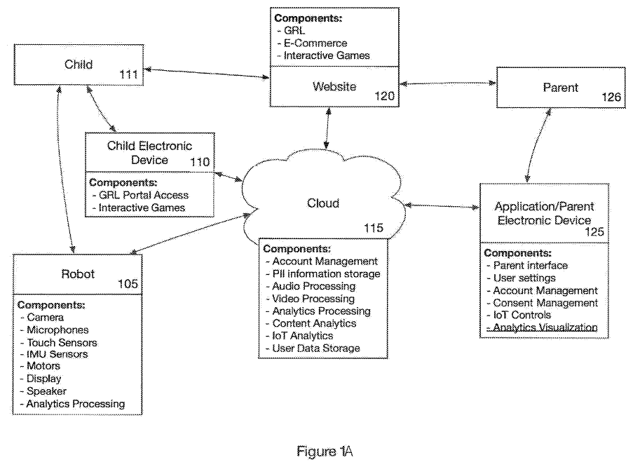

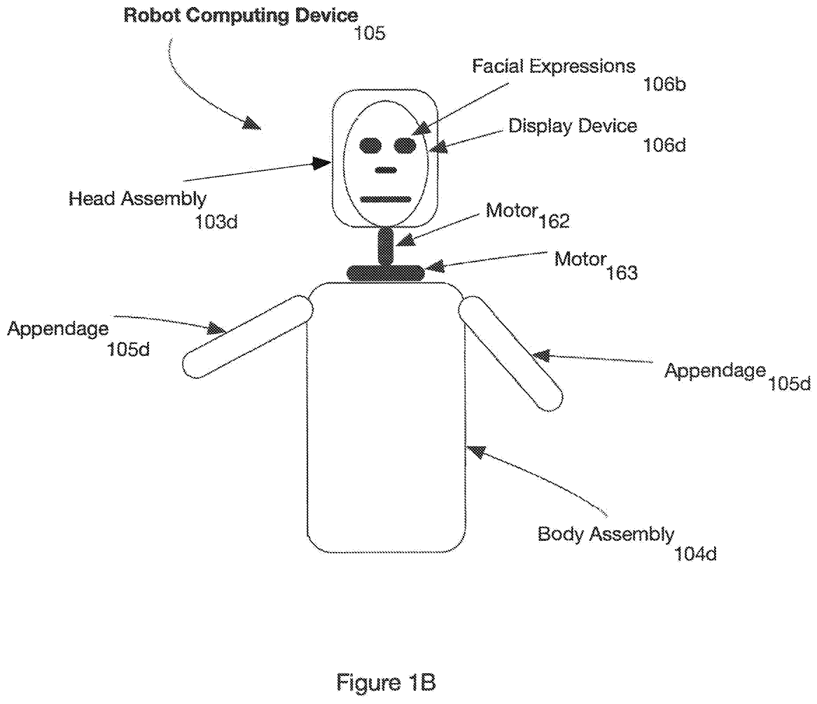

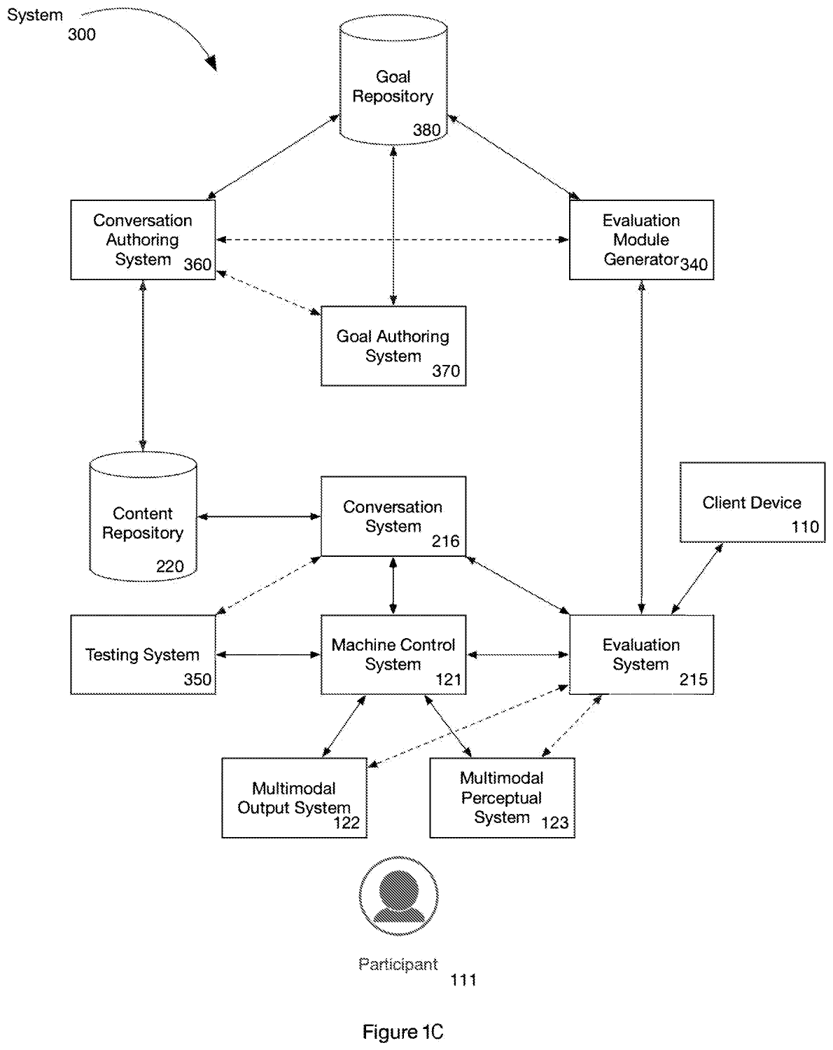

FIG. 1A illustrates a system for a social robot or digital companion to engage a child and/or a parent, in accordance with one or more implementations. In some implementations, a robot computing device 105 (or digital companion) may engage with a child and establish communication interactions with the child and/or a child's computing device. In some implementations, there will be bidirectional communication between the robot computing device 105 and the child 111 with a goal of establishing multi-turn conversations (e.g., both parties taking more than one conversation turns) in the communication interactions. In some implementations, the robot computing device 105 may communicate with the child via spoken words (e.g., audio actions,), visual actions (movement of eyes or facial expressions on a display screen or presentation of graphics or graphic images on a display screen), and/or physical actions (e.g., movement of a neck, a head or an appendage of a robot computing device). In some implementations, the robot computing device 105 may utilize one or more imaging devices to capture a child's body language, facial expressions and/or a gesture a child is making. In some embodiments, the robot computing device 105 may use one or more microphones and speech recognition software to capture and/or record the child's speech.

In some implementations, the child may also have one or more electronic devices 110, which may be referred to as a child electronic device. In some embodiments, the one or more electronic devices may be a tablet computing device, a mobile communications device (e.g., smartphone), a laptop computing device and/or a desktop computing device. In some implementations, the one or more electronic devices 110 may allow a child to login to a website on a server or other cloud-based computing device in order to access a learning laboratory and/or to engage in interactive games that are housed and/or stored on the web site. In some implementations, the child's one or more computing devices 110 may communicate with cloud computing devices 115 in order to access the website 120. In some implementations, the website 120 may be housed on server computing devices or cloud-based computing devices. In some implementations, the website 120 may include the learning laboratory (which may be referred to as a global robotics laboratory (GRL) where a child can interact with digital characters or personas that are associated with the robot computing device 105. In some implementations, the website 120 may include interactive games where the child can engage in competitions or goal setting exercises. In some implementations, other users or a child computing device (with the necessary consent of other users) may be able to interface with an e-commerce website or program. The child (with appropriate consent) or the parent or guardian or other adults may purchase items that are associated with the robot computing devices (e.g., comic books, toys, badges or other affiliate items).

In some implementations, the robot computing device or digital companion 105 may include one or more imaging devices, one or more microphones, one or more touch sensors, one or more IM U sensors, one or more motors and/or motor controllers, one or more display devices or monitors and/or one or more speakers. In some implementations, the robot computing device or digital companion 105 may include one or more processors, one or more memory devices, and/or one or more wireless communication transceivers. In some implementations, computer-readable instructions may be stored in the one or more memory devices and may be executable by the one or more processors to cause the robot computing device or digital companion 105 to perform numerous actions, operations and/or functions. In some implementations, the robot computing device or digital companion may perform analytics processing with respect to captured data, captured parameters and/or measurements, captured audio files and/or image files that may be obtained from the components of the robot computing device in is interactions with the users and/or environment.

In some implementations, the one or more touch sensors may measure if a user (child, parent or guardian) touches a portion of the robot computing device or if another object or individual comes into contact with the robot computing device. In some implementations, the one or more touch sensors may measure a force of the touch, dimensions and/or direction of the touch to determine, for example, if it is an exploratory touch, a push away, a hug or another type of action. In some implementations, for example, the touch sensors may be located or positioned on a front and back of an appendage or a hand or another limb of the robot computing device, or on a stomach or body or back or head area of the robot computing device or digital companion 105. Thus, based at least in part on the measurements or parameters received from the touch sensors, computer-readable instructions executable by one or more processors of the robot computing device may determine if a child is shaking a hand, grabbing a hand of the robot computing device, or if they are rubbing the stomach or body of the robot computing device 105. In some implementations, other touch sensors may determine if the child is hugging the robot computing device 105. In some implementations, the touch sensors may be utilized in conjunction with other robot computing device software where the robot computing device may be able tell a child to hold their left hand if they want to follow one path of a story or hold a left hand if they want to follow the other path of a story.

In some implementations, the one or more imaging devices may capture images and/or video of a child, parent or guardian interacting with the robot computing device. In some implementations, the one or more imaging devices may capture images and/or video of the area around (e.g., the environment around) the child, parent or guardian. In some implementations, the captured images and/or video may be processed and/or analyzed to determine who is speaking with the robot computing device or digital companion 105. In some implementations, the captured images and/or video may be processed and/or analyzed to create a world map or area map of the surrounding around the robot computing device. In some implementations, the one or more microphones may capture sound or verbal commands spoken by the child, parent or guardian. In some implementations, computer-readable instructions executable by the one or more processors or an audio processing device may convert the captured sounds or utterances into audio files for processing. In some implementations, the captured audio or video files and/or audio files may be utilized to identify facial expressions and/or to help determine future actions performed or spoken by the robot device.

In some implementations, the one or more IMU sensors may measure velocity, acceleration, orientation and/or location of different parts of the robot computing device. In some implementations, for example, the IMU sensors may determine the speed of movement of an appendage or a neck. In some implementations, for example, the IMU sensors may determine an orientation of a section or the robot computing device, e.g., a neck, a head, a body or an appendage, in order to identify if the hand is waving or in a rest position. In some implementations, the use of the IMU sensors may allow the robot computing device to orient its different sections (of the body) in order to appear more friendly or engaging to the user.

In some implementations, the robot computing device or digital companion may have one or more motors and/or motor controllers. In some implementations, the computer-readable instructions may be executable by the one or more processors. In response, commands or instructions may be communicated to the one or more motor controllers to send signals or commands to the motors to cause the motors to move sections of the robot computing device. In some implementations, the sections that are moved by the one or more motors and/or motor controllers may include appendages or arms of the robot computing device, a neck and/or or a head of the robot computing device 105. In some implementations, the robot computing device may also include a drive system such as a tread, wheels or a tire, a motor to rotate a shaft to engage the drive system and move the tread, wheels or the tire, and a motor controller to activate the motor. In some implementations, this may allow the robot computing device to move.

In some implementations, the robot computing device 105 may include a display or monitor, which may be referred to as an output modality. In some implementations, the monitor may allow the robot computing device to display facial expressions (e.g., eyes, nose, or mouth expressions) as well as to display video, messages and/or graphic images to the child, parent or guardian.

In some implementations, the robot computing device or digital companion 105 may include one or more speakers, which may be referred to as an output modality. In some implementations, the one or more speakers may enable or allow the robot computing device to communicate words, phrases and/or sentences and thus engage in conversations with the user. In addition, the one or more speakers may emit audio sounds or music for the child, parent or guardian when they are performing actions and/or engaging with the robot computing device 105.

In some implementations, the system may include a parent computing device 125. In some implementations, the parent computing device 125 may include one or more processors and/or one or more memory devices. In some implementations, computer-readable instructions may be executable by the one or more processors to cause the parent computing device 125 to engage in a number of actions, operations and/or functions. In some implementations, these actions, features and/or functions may include generating and running a parent interface for the system (e.g., to communicate with the one or more cloud servers 115). In some implementations, the software (e.g., computer-readable instructions executable by the one or more processors) executable by the parent computing device 125 may allow alteration and/or changing user (e.g., child, parent or guardian) settings. In some implementations, the software executable by the parent computing device 125 may also allow the parent or guardian to manage their own account or their child's account in the system. In some implementations, the software executable by the parent computing device 125 may allow the parent or guardian to initiate or complete parental consent to allow certain features of the robot computing device to be utilized. In some implementations, this may include initial parental consent for video and/or audio of a child to be utilized. In some implementations, the software executable by the parent computing device 125 may allow a parent or guardian to set goals or thresholds for the child; to modify or change settings regarding what is captured from the robot computing device 105, and to determine what parameters and/or measurements are analyzed and/or utilized by the system. In some implementations, the software executable by the one or more processors of the parent computing device 125 may allow the parent or guardian to view the different analytics generated by the system (e.g., cloud server computing devices 115) in order to see how the robot computing device is operating, how their child is progressing against established goals, and/or how the child is interacting with the robot computing device 105.

In some implementations, the system may include a cloud server computing device 115. In some implementations, the cloud server computing device 115 may include one or more processors and one or more memory devices. In some implementations, computer-readable instructions may be retrieved from the one or more memory devices and executable by the one or more processors to cause the cloud server computing device 115 to perform calculations, process received data, interface with the website 120 and/or handle additional functions. In some implementations, the software (e.g., the computer-readable instructions executable by the one or more processors) may manage accounts for all the users (e.g., the child, the parent and/or the guardian). In some implementations, the software may also manage the storage of personally identifiable information (PII) in the one or more memory devices of the cloud server computing device 115 (as well as encryption and/or protection of the PII). In some implementations, the software may also execute the audio processing (e.g., speech recognition and/or context recognition) of sound files that are captured from the child, parent or guardian and turning these into command files, as well as generating speech and related audio files that may be spoken by the robot computing device 115 when engaging the user. In some implementations, the software in the cloud server computing device 115 may perform and/or manage the video processing of images that are received from the robot computing devices. In some implementations, this may include facial recognition and/or identifying other items or objects that are in an environment around a user.

In some implementations, the software of the cloud server computing device 115 may analyze received inputs from the various sensors and/or other input modalities as well as gather information from other software applications as to the child's progress towards achieving set goals. In some implementations, the cloud server computing device software may be executable by the one or more processors in order to perform analytics processing. In some implementations, analytics processing may be analyzing behavior on how well the child is doing in conversing with the robot (or reading a book or engaging in other activities) with respect to established goals.

In some implementations, the system may also store augmented content for reading material in one or more memory devices. In some implementations, the augmented content may be audio files, visual effect files and/or video/image files that are related to reading material the user may be reading or speaking about. In some implementations, the augmented content may be instructions or commands for a robot computing device to perform some actions (e.g., change facial expressions, change tone or volume level of speech and/or move an arm or the neck or head). In some implementations, the software of the cloud server computing device 115 may receive input regarding how the user or child is responding to content, for example, does the child like the story, the augmented content, and/or the output being generated by the one or more output modalities of the robot computing device. In some implementations, the cloud server computing device 115 may receive the input regarding the child's response to the content and may perform analytics on how well the content is working and whether or not certain portions of the content may not be working (e.g., perceived as boring or potentially malfunctioning or not working). This may be referred to as the cloud server computing device (or cloud-based computing device) performing content analytics.

In some implementations, the software of the cloud server computing device 115 may receive inputs such as parameters or measurements from hardware components of the robot computing device such as the sensors, the batteries, the motors, the display and/or other components. In some implementations, the software of the cloud server computing device 115 may receive the parameters and/or measurements from the hardware components and may perform IOT Analytics processing on the received parameters, measurements or data to determine if the robot computing device as is desired, or if the robot computing device 115 is malfunctioning and/or not operating at an optimal manner. In some implementations, the software of the cloud-server computing device 115 may perform other analytics processing on the received parameters, measurements and/or data.

In some implementations, the cloud server computing device 115 may include one or more memory devices. In some implementations, portions of the one or more memory devices may store user data for the various account holders. In some implementations, the user data may be user address, user goals, user details and/or preferences. In some implementations, the user data may be encrypted and/or the storage may be a secure storage.

FIG. 1C illustrates functional modules of a system including a robot computing device according to some implementations. In some embodiments, at least one method described herein is performed by a system 300 that includes the conversation system 216, a machine control system 121, a multimodal output system 122, a multimodal perceptual system 123, and/or an evaluation system 215. In some implementations, at least one of the conversation system or module 216, a machine control system 121, a multimodal output system 122, a multimodal perceptual system 123, and an evaluation system 215 may be included in a robot computing device, a digital companions or a machine. In some embodiments, the machine may a robot. In some implementations, the conversation system 216 may be communicatively coupled to control system 121 of the robot computing device. In some embodiments, the conversation system may be communicatively coupled to the evaluation system 215. In some implementations, the conversation system 216 may be communicatively coupled to a conversational content repository 220. In some implementations, the conversation system 216 may be communicatively coupled to a conversation testing system 350. In some implementations, the conversation system 216 may be communicatively coupled to a conversation authoring system 141. In some implementations, the conversation system 216 may be communicatively coupled to a goal authoring system 140. In some implementations, the conversation system 216 may be a cloud-based conversation system provided by a conversation system server that is communicatively coupled to the control system 121 via the Internet. In some implementations, the conversation system may be the Embodied Chat Operating System.

In some implementations, the conversation system 216 may be an embedded conversation system that is included in the robot computing device or implementations. In some implementations, the control system 121 may be constructed to control a multimodal output system 122 and a multi modal perceptual system 123 that includes one or more sensors. In some implementations, the control system 121 may be constructed to interact with the conversation system 216. In some implementations, the machine or robot computing device may include the multimodal output system 122. In some implementations, the multimodal output system 122 may include at least one of an audio output sub-system, a video display sub-system, a mechanical robotic subsystem, a light emission sub-system, a LED (Light Emitting Diode) ring, and/or a LED (Light Emitting Diode) array. In some implementations, the machine or robot computing device may include the multimodal perceptual system 123, wherein the multimodal perceptual system 123 may include the at least one sensor. In some implementations, the multimodal perceptual system 123 includes at least one of a sensor of a heat detection sub-system, a sensor of a video capture sub-system, a sensor of an audio capture sub-system, a touch sensor, a piezoelectric pressor sensor, a capacitive touch sensor, a resistive touch sensor, a blood pressure sensor, a heart rate sensor, and/or a biometric sensor. In some implementations, the evaluation system 215 may be communicatively coupled to the control system 121. In some implementations, the evaluation system 215 may be communicatively coupled to the multimodal output system 122. In some implementations, the evaluation system 215 may be communicatively coupled to the multimodal perceptual system 123. In some implementations, the evaluation system 215 may be communicatively coupled to the conversation system 216. In some implementations, the evaluation system 215 may be communicatively coupled to a client device 110 (e.g., a parent or guardian's mobile device or computing device). In some implementations, the evaluation system 215 may be communicatively coupled to the goal authoring system 140. In some implementations, the evaluation system 215 may include computer-readable-instructions of a goal evaluation module that, when executed by the evaluation system, may control the evaluation system 215 to process information generated from the multimodal perceptual system 123 to evaluate a goal associated with conversational content processed by the conversation system 216. In some implementations, the goal evaluation module is generated based on information provided by the goal authoring system 140.

In some implementations, the goal evaluation module 215 may be generated based on information provided by the conversation authoring system 140. In some embodiments, the goal evaluation module 215 may be generated by an evaluation module generator 142. In some implementations, the conversation testing system may receive user input from a test operator and may provide the control system 121 with multimodal output instructions (either directly or via the conversation system 216). In some implementations, the conversation testing system 350 may receive event information indicating a human response sensed by the machine or robot computing device (either directly from the control system 121 or via the conversation system 216). In some implementations, the conversation authoring system 141 may be constructed to generate conversational content and store the conversational content in one of the content repository 220 and the conversation system 216. In some implementations, responsive to updating of content currently used by the conversation system 216, the conversation system may be constructed to store the updated content at the content repository 220.

In some embodiments, the goal authoring system 140 may be constructed to generate goal definition information that is used to generate conversational content. In some implementations, the goal authoring system 140 may be constructed to store the generated goal definition information in a goal repository 143. In some implementations, the goal authoring system 140 may be constructed to provide the goal definition information to the conversation authoring system 141. In some implementations, the goal authoring system 143 may provide a goal definition user interface to a client device that includes fields for receiving user-provided goal definition information. In some embodiments, the goal definition information specifies a goal evaluation module that is to be used to evaluate the goal. In some implementations, each goal evaluation module is at least one of a sub-system of the evaluation system 215 and a sub-system of the multimodal perceptual system 123. In some embodiments, each goal evaluation module uses at least one of a sub-system of the evaluation system 215 and a sub-system of the multimodal perceptual system 123. In some implementations, the goal authoring system 140 may be constructed to determine available goal evaluation modules by communicating with the machine or robot computing device, and update the goal definition user interface to display the determined available goal evaluation modules.

In some implementations, the goal definition information defines goal levels for goal. In some embodiments, the goal authoring system 140 defines the goal levels based on information received from the client device (e.g., user-entered data provided via the goal definition user interface). In some embodiments, the goal authoring system 140 automatically defines the goal levels based on a template. In some embodiments, the goal authoring system 140 automatically defines the goal levels based on information provided by the goal repository 143, which stores information of goal levels defined form similar goals. In some implementations, the goal definition information defines participant support levels for a goal level. In some embodiments, the goal authoring system 140 defines the participant support levels based on information received from the client device (e.g., user-entered data provided via the goal definition user interface). In some implementations, the goal authoring system 140 may automatically define the participant support levels based on a template. In some embodiments, the goal authoring system 140 may automatically define the participant support levels based on information provided by the goal repository 143, which stores information of participant support levels defined form similar goal levels. In some implementations, conversational content includes goal information indicating that a specific goal should be evaluated, and the conversational system 216 may provide an instruction to the evaluation system 215 (either directly or via the control system 121) to enable the associated goal evaluation module at the evaluation system 215. In a case where the goal evaluation module is enabled, the evaluation system 215 executes the instructions of the goal evaluation module to process information generated from the multimodal perceptual system 123 and generate evaluation information. In some implementations, the evaluation system 215 provides generated evaluation information to the conversation system 215 (either directly or via the control system 121). In some implementations, the evaluation system 215 may update the current conversational content at the conversation system 216 or may select new conversational content at the conversation system 100 (either directly or via the control system 121), based on the evaluation information.

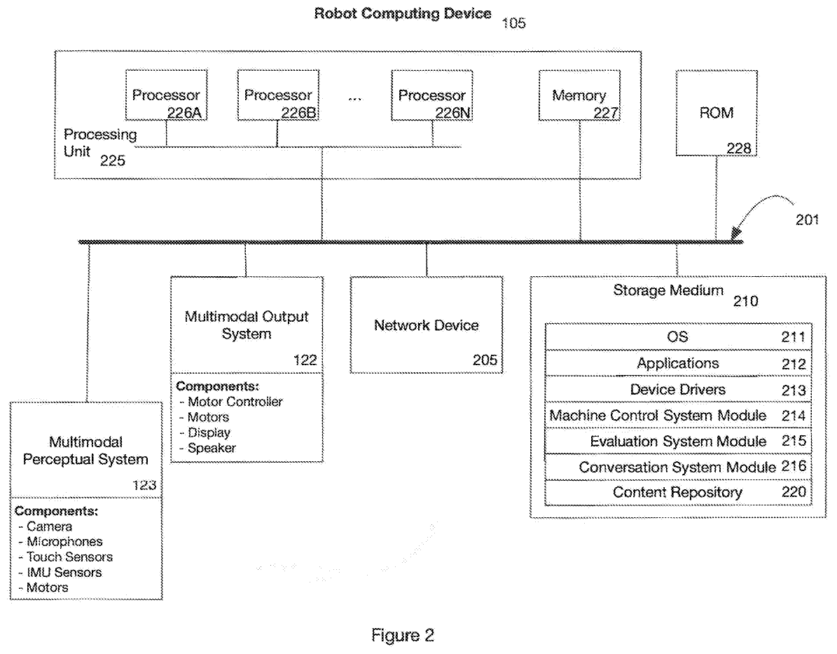

FIG. 1B illustrates a robot computing device according to some implementations. In some implementations, the robot computing device 105 may be a machine, a digital companion, an electro-mechanical device including computing devices. These terms may be utilized interchangeably in the specification. In some implementations, as shown in FIG. 1B, the robot computing device 105 may include a head assembly 103d, a display device 106d, at least one mechanical appendage 105d (two are shown in FIG. 1B), a body assembly 104d, a vertical axis rotation motor 163, and/or a horizontal axis rotation motor 162. In some implementations, the robot computing device may include a multimodal output system 122 and the multimodal perceptual system 123 (not shown in FIG. 1B, but shown in FIG. 2 below). In some implementations, the display device 106d may allow facial expressions 106b to be shown or illustrated after being generated. In some implementations, the facial expressions 106b may be shown by the two or more digital eyes, a digital nose and/or a digital mouth. In some implementations, other images or parts may be utilized to show facial expressions. In some implementations, the horizontal axis rotation motor 163 may allow the head assembly 103d to move from side-to-side which allows the head assembly 103d to mimic human neck movement like shaking a human's head from side-to-side. In some implementations, the vertical axis rotation motor 162 may allow the head assembly 103d to move in an up-and-down direction like shaking a human's head up and down. In some implementations, an additional motor may be utilized to move the robot computing device (e.g., the entire robot or computing device) to a new position or geographic location in a room or space (or even another room). In this implementation, the additional motor may be connected to a drive system that causes wheels, tires or treads to rotate and thus physically move the robot computing device.

In some implementations, the body assembly 104d may include one or more touch sensors. In some implementations, the body assembly's touch sensor(s) may allow the robot computing device to determine if it is being touched or hugged. In some implementations, the one or more appendages 105d may have one or more touch sensors. In some implementations, some of the one or more touch sensors may be located at an end of the appendages 105d (which may represent the hands). In some implementations, this allows the robot computing device 105 to determine if a user or child is touching the end of the appendage (which may represent the user shaking the user's hand).

FIG. 2 is a diagram depicting system architecture of a robot computing device (e.g., 105 of FIG. 1B), according to implementations. In some implementations, the robot computing device or system of FIG. 2 may be implemented as a single hardware device. In some implementations, the robot computing device and system of FIG. 2 may be implemented as a plurality of hardware devices. In some implementations, portions of the robot computing device and system of FIG. 2 may be implemented as an ASIC (Application-Specific Integrated Circuit). In some implementations, portions of the robot computing device and system of FIG. 2 may be implemented as an FPGA (Field-Programmable Gate Array). In some implementations, the robot computing device and system of FIG. 2 may be implemented as a SoC (System-on-Chip).

In some implementations, a communication bus 201 may interface with the processors 226A-N, the main memory 227 (e.g., a random access memory (RAM) or memory modules), a read only memory (ROM) 228 (or ROM modules), one or more processor-readable storage mediums 210, and one or more network devices 211. In some implementations, a bus 201 may interface with at least one display device (e.g., 102c in FIG. 1B and part of the multimodal output system 122) and a user input device (which may be part of multimodal perception or input system 123). In some implementations, bus 101 may interface with the multimodal output system 122. In some implementations, the multimodal output system 122 may include an audio output controller. Light emitting diodes and/or light bars may be utilized as displays of the robot computing device. In some implementations, the multimodal output system 122 may include a speaker. In some implementations, the multimodal output system 122 may include a display system or monitor. In some implementations, the multimodal output system 122 may include a motor controller. In some implementations, the motor controller may be constructed to control the one or more appendages (e.g., 105d) of the robot system of FIG. 1B via the one or more motors. In some implementations, the motor controller may be constructed to control a motor of a head or neck of the robot system or computing device of FIG. 1B.

In some implementations, a bus 201 may interface with the multimodal perceptual system 123 (which may be referred to as a multimodal input system or multimodal input modalities). In some implementations, the multimodal perceptual system 123 may include one or more audio input processors. In some implementations, the multimodal perceptual system 123 may include a human reaction detection sub-system. In some implementations, the multimodal perceptual system 123 may include one or more microphones. In some implementations, the multimodal perceptual system 123 may include one or more camera(s) or imaging devices. In some implementations, the multimodal perception system 123 may include one or more IMU sensors and/or one or more touch sensors.

In some implementations, the one or more processors 226A-226N may include one or more of an ARM processor, an X86 processor, a GPU (Graphics Processing Unit), other manufacturers processors, and/or the like. In some implementations, at least one of the processors may include at least one arithmetic logic unit (ALU) that supports a SIMD (Single Instruction Multiple Data) system that provides native support for multiply and accumulate operations.

In some implementations, at least one of a central processing unit (processor), a GPU, and a multi-processor unit (MPU) may be included. In some implementations, the processors and the main memory form a processing unit 225 (as is shown in FIG. 2). In some implementations, the processing unit 225 includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some implementations, the processing unit is an ASIC (Application-Specific Integrated Circuit).

In some implementations, the processing unit may be a SoC (System-on-Chip). In some implementations, the processing unit may include at least one arithmetic logic unit (ALU) that supports a SIMD (Single Instruction Multiple Data) system that provides native support for multiply and accumulate operations. In some implementations the processing unit is a Central Processing Unit such as an Intel Xeon processor. In other implementations, the processing unit includes a Graphical Processing Unit such as NVIDIA Tesla.

In some implementations, the one or more network adapter devices or network interface devices 205 may provide one or more wired or wireless interfaces for exchanging data and commands. Such wired and wireless interfaces include, for example, a universal serial bus (USB) interface, a Bluetooth interface (or other personal area network (PAN) interfaces), a Wi-Fi interface (or other 802.11 wireless interfaces), an Ethernet interface (or other LAN interfaces), near field communication (NFC) interface, cellular communication interfaces, and the like. In some implementations, the one or more network adapter devices or network interface devices 205 may be wireless communication devices. In some implementations, the one or more network adapter devices or network interface devices 205 may include personal area network (PAN) transceivers, wide area network communication transceivers and/or cellular communication transceivers.

In some implementations, the one or more network devices 205 may be communicatively coupled to another robot computing device or digital companion (e.g., a robot computing device similar to the robot computing device 105 of FIG. 1B). In some implementations, the one or more network devices 205 may be communicatively coupled to an evaluation system module (e.g., 215). In some implementations, the one or more network devices 205 may be communicatively coupled to a conversation system module (e.g., 216). In some implementations, the one or more network devices 205 may be communicatively coupled to a testing system. In some implementations, the one or more network devices 205 may be communicatively coupled to a content repository (e.g., 220). In some implementations, the one or more network devices 205 may be communicatively coupled to a client computing device (e.g., 110). In some implementations, the one or more network devices 205 may be communicatively coupled to a conversation authoring system (e.g., 160). In some implementations, the one or more network devices 205 may be communicatively coupled to an evaluation module generator. In some implementations, the one or more network devices may be communicatively coupled to a goal authoring system. In some implementations, the one or more network devices 205 may be communicatively coupled to a goal repository. In some implementations, machine-executable instructions in software programs (such as an operating system 211, application programs 212, and device drivers 213) may be loaded into the one or more memory devices (of the processing unit) from the processor-readable storage medium 210, the ROM or any other storage location. During execution of these software programs, the respective machine-executable instructions may be accessed by at least one of processors 226A-226N (of the processing unit) via the bus 201, and then may be executed by at least one of processors. Data used by the software programs may also be stored in the one or more memory devices, and such data is accessed by at least one of one or more processors 226A-226N during execution of the machine-executable instructions of the software programs.

In some implementations, the processor-readable storage medium 210 may be one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. In some implementations, the processor-readable storage medium 210 may include machine-executable instructions (and related data) for an operating system 211, software programs or application software 212, device drivers 213, and machine-executable instructions for one or more of the processors 226A-226N of FIG. 2.

In some implementations, the processor-readable storage medium 210 may include a machine control system module 214 that includes machine-executable instructions for controlling the robot computing device to perform processes performed by the machine control system, such as moving the head assembly of robot computing device, the neck assembly of the robot computing device and/or an appendage of the robot computing device.

In some implementations, the processor-readable storage medium 210 may include an evaluation system module 215 that includes machine-executable instructions for controlling the robotic computing device to perform processes performed by the evaluation system. In some implementations, the processor-readable storage medium 210 may include a conversation system module 216 that may include machine-executable instructions for controlling the robot computing device 105 to perform processes performed by the conversation system. In some implementations, the processor-readable storage medium 210 may include machine-executable instructions for controlling the robot computing device 105 to perform processes performed by the testing system. In some implementations, the processor-readable storage medium 210, machine-executable instructions for controlling the robot computing device 105 to perform processes performed by the conversation authoring system.

In some implementations, the processor-readable storage medium 210, machine-executable instructions for controlling the robot computing device 105 to perform processes performed by the goal authoring system 140. In some implementations, the processor-readable storage medium 210 may include machine-executable instructions for controlling the robot computing device 105 to perform processes performed by the evaluation module generator 142.

In some implementations, the processor-readable storage medium 210 may include the content repository 220. In some implementations, the processor-readable storage medium 210 may include the goal repository 180. In some implementations, the processor-readable storage medium 210 may include machine-executable instructions for an emotion detection module. In some implementations, emotion detection module may be constructed to detect an emotion based on captured image data (e.g., image data captured by the perceptual system 123 and/or one of the imaging devices). In some implementations, the emotion detection module may be constructed to detect an emotion based on captured audio data (e.g., audio data captured by the perceptual system 123 and/or one of the microphones). In some implementations, the emotion detection module may be constructed to detect an emotion based on captured image data and captured audio data. In some implementations, emotions detectable by the emotion detection module include anger, contempt, disgust, fear, happiness, neutral, sadness, and surprise. In some implementations, emotions detectable by the emotion detection module include happy, sad, angry, confused, disgusted, surprised, calm, unknown. In some implementations, the emotion detection module is constructed to classify detected emotions as either positive, negative, or neutral. In some implementations, the robot computing device 105 may utilize the emotion detection module to obtain, calculate or generate a determined emotion classification (e.g., positive, neutral, negative) after performance of an action by the machine or robot computing device, and store the determined emotion classification in association with the performed action (e.g., in the storage medium 210).

In some implementations, the testing system 350 may be a hardware device or computing device separate from the robot computing device, and the testing system may include at least one processor, a memory, a ROM, a network device, and a storage medium (constructed in accordance with a system architecture similar to a system architecture described herein for the machine 120), wherein the storage medium stores machine-executable instructions for controlling the testing system to perform processes performed by the testing system, as described herein.

In some implementations, the conversation authoring system 141 may be a hardware device separate from the robot computing device 105, and the conversation authoring system 141 may include at least one processor, a memory, a ROM, a network device, and a storage medium (constructed in accordance with a system architecture similar to a system architecture described herein for the robot computing device 105), wherein the storage medium stores machine-executable instructions for controlling the conversation authoring system to perform processes performed by the conversation authoring system.

In some implementations, the evaluation module generator 142 may be a hardware device separate from the robot computing device 105, and the evaluation module generator 142 may include at least one processor, a memory, a ROM, a network device, and a storage medium (constructed in accordance with a system architecture similar to a system architecture described herein for the robot computing device), wherein the storage medium stores machine-executable instructions for controlling the evaluation module generator 142 to perform processes performed by the evaluation module generator, as described herein.

In some implementations, the goal authoring system 140 may be a hardware device separate from the robot computing device, and the goal authoring system may include at least one processor, a memory, a ROM, a network device, and a storage medium (constructed in accordance with a system architecture similar to a system architecture described instructions for controlling the goal authoring system to perform processes performed by the goal authoring system. In some implementations, the storage medium of the goal authoring system may include data, settings and/or parameters of the goal definition user interface described herein. In some implementations, the storage medium of the goal authoring system may include machine-executable instructions of the goal definition user interface described herein (e.g., the user interface). In some implementations, the storage medium of the goal authoring system may include data of the goal definition information described herein (e.g., the goal definition information). In some implementations, the storage medium of the goal authoring system may include machine-executable instructions to control the goal authoring system to generate the goal definition information described herein (e.g., the goal definition information).

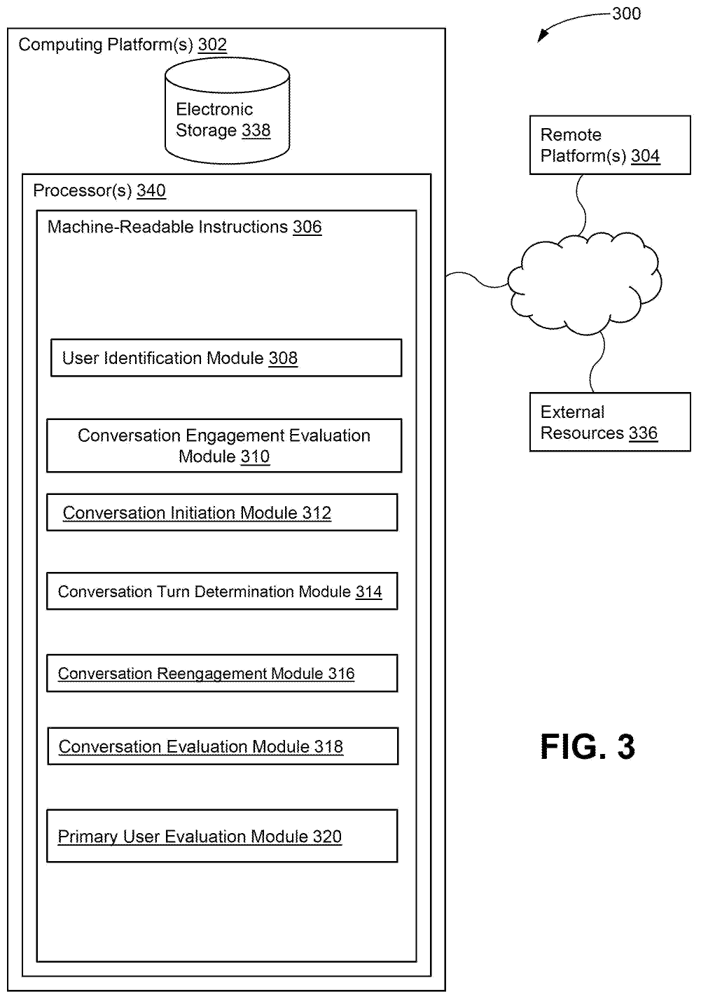

FIG. 3 illustrates a system 300 configured to manage communication interactions between a user and a robot computing device, in accordance with one or more implementations. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304. One or more components described in connection with system 300 may be the same as or similar to one or more components described in connection with FIGS. 1A, 1B, and 2. For example, in some implementations, computing platform(s) 302 and/or remote platform(s) 304 may be the same as or similar to one or more of the robot computing device 105, the one or more electronic devices 110, the cloud server computing device 115, the parent computing device 125, and/or other components.

Computing platform(s) 302 may be configured by computer-readable instructions 306. Computer-readable instructions 306 may include one or more instruction modules. The instruction modules may include computer program modules. The instruction modules may include one or more of user identification module 308, conversation engagement evaluation module 310, conversation initiation module 312, conversation turn determination module 314, conversation reengagement determination module 316, conversation evaluation module 318, and/or primary user identification module 320.

In some implementations, user identification module 308 may be configured to receive one or more inputs including parameters or measurements regarding a physical environment from the one or more input modalities.

In some implementations, user identification module 308 may be configured to receive one or more inputs including parameters or measurements regarding a physical environment from one or more input modalities of another robot computing device. By way of non-limiting example, the one or more input modalities may include one or more sensors, one or more microphones, or one or more imaging devices.

In some implementations, user identification module 308 may be configured to identify a user based on analyzing the received inputs from the one or more input modalities.

In some implementations, conversation engagement evaluation module 310 may be configured to determine if the user shows signs of engagement or interest in establishing a communication interaction by analyzing a user's physical actions, visual actions, and/or audio actions. In some implementations, the user's physical actions, visual actions and/or audio actions may be determined based at least in part on the one or more inputs received from the one or more input modalities.

In some implementations, conversation engagement evaluation module 310 may be configured to determine whether the user is interested in an extended communication interaction with the robot computing device by creating visual actions of the robot computing device utilizing the display device or by generating one or more audio files to be reproduced by one or more speakers of the robot computing device.

In some implementations, conversation engagement evaluation module 310 may be configured to determine the user's interest in the extended communication interaction by analyzing the user's audio input files received from the one or more microphones by examining linguistic context of the user and voice inflection of the user.

In some implementations, conversation initiation module 312 may be configured to determine whether to initiate a conversation turn in the extended communication interaction with the user by analyzing the user's facial expression. The user's posture may and/or the user's gestures, which are captured by the imaging device and/or the sensor devices.

In some implementations, conversation initiation module 312 may be configured to determine whether to initiate a conversation turn in the extended communication interaction with the user by analyzing the user's audio input files received from the one or more microphones to examine the user's linguistic context and the user's voice inflection.

In some implementations, conversation turn determination module 314 may be configured to initiate the conversation turn in the extended communication interaction with the user by communication one or more audio files to a speaker.

In some implementations, conversation turn determination module 314 may be configured to determine when to end the conversation turn in the extended communication interaction with the user by analyzing the user's facial expression. The user's posture may and/or the user's gestures, which are captured by the imaging device and/or the sensor devices. Stop the conversation turn in the extended communication interaction by may stop transmission of audio files to the speaker.

In some implementations, conversation turn determination module 314 may be configured to determine when to end the conversation turn in the extended communication interaction with the user by analyzing the user's audio input files received from the one or more microphones to examine the user's linguistic context and the user's voice inflection.

In some implementations, conversation turn determination module 314 may be configured to stop the conversation turn in the extended communication interaction by stopping transmission of audio files to the speaker.

In some implementations, conversation reengagement module 316 may be configured to generate actions or events for the output modalities of the robot computing device to attempt to re-engage the user to continue to engage in the extended communication interaction. In some implementations, the generated actions or events may include transmitting audio files to one or more speakers of the robot computing device to speak to the user. In some implementations, the generation actions or events may include transmitting commands or instructions to the display or monitor of the robot computing device to try to get the user's attention. In some implementations, the generated actions or events may include transmitting commands or instructions to the one or more motors of the robot computing device to move one or more appendages and/or other sections (e.g., head or neck) of the robot computing device.

In some implementations, conversation evaluation module 318 may be configured to retrieve past parameters and measurements from a memory device of the robot computing device. In some implementations, the past parameters or measurements may be utilized by the conversation evaluation module 318 to generate audible actions, visual actions and/or physical actions to attempt to increase engagement with the user and/or to extend a communication interaction. In some implementations, the response to the actions or events may cause the conversation evaluation module to end an extended communication interaction.

In some implementations, the past parameters or measurements may include an indicator of how successful a past communication interaction was with a user. In some implementations, the conversation evaluation module 318 may utilize a past communication interaction with a highest indicator value as a model communication interaction for the current communication interaction.

In some implementations, the conversation evaluation module 318 may continue to engage in conversation turns until the user disengages. In some implementations, the conversation evaluation module 318, while the conversation interaction is ongoing with measure a length of time of the current communication interaction. In some implementations, when the communication interaction ends, the conversation evaluation module 318 will stop the measurement of time and store the length of time for the extended communication interaction in a memory of the robot computing device along with other measurements and parameters of the extended communication interaction.

In some implementations, the robot computing device may be faced with a situation where two or more users are in an area. In some implementations, primary user evaluation module may be configured to identify a primary user from other individuals or users in area around the robot computing device. In some implementations, primary user evaluation module 320 may parameters or measurements about a physical environment around a first user and a second user. In some implementations, a primary user evaluation module 320 may be configured to determine whether the first user and the second user show signs of engagement or interest in establishing an extended communication interaction by analyzing the first user's and the second user's physical actions, visual actions and/or audio actions. If the first user and second user show interest, the primary user evaluation module 320 may try to interest the first user and the second user by having the robot computing device create visual actions, audio actions and/or physical actions (as has been described above and below). In some implementations, the primary user evaluation module 320 may be configured to retrieve parameters or measurements from a memory of a robot computing device to identify parameters or measurements of a primary user. In some implementations, the primary user evaluation module 320 may be configured to compare the retrieved parameters or measurements to the received parameters from the first user and also to compare to the received parameters from the second user and further to determine a closest match to the retrieved parameters of the primary user. In some implementations, the primary user evaluation module 320 may then prioritize and thus engage in the extended communication interaction with the user having the closest match to the retrieved parameters of the primary user.

In some implementations, computing platform(s) 302, remote platform(s) 304, and/or external resources 336 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 336 may be operatively linked via some other communication media.

A given remote platform 304 may include one or more processors configured to execute computer program modules. The computer program modules may be configured to enable an expert or user associated with the given remote platform 304 to interface with system 300 and/or external resources 336, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 336 may include sources of information outside of system 300, external entities participating with system 300, and/or other resources. In some implementations, some or all of the functionality attributed herein to external resources 336 may be provided by resources included in system 300.

Computing platform(s) 302 may include electronic storage 338, one or more processors 340, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 338 may comprise non-transitory storage media that electronically stores information. The electronic storage media of electronic storage 338 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 338 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 338 may include one or more virtual storage resources (e.g., cloud storage, a virtual private network, and/or other virtual storage resources). Electronic storage 340 may store software algorithms, information determined by processor(s) 340, information received from computing platform(s) 302, information received from remote platform(s) 304, and/or other information that enables computing platform(s) 302 to function as described herein.

Processor(s) 340 may be configured to provide information processing capabilities in computing platform(s) 302. As such, processor(s) 340 may include one or more of a digital processor, an analog processor, a digital circuit designed to process information, an analog circuit designed to process information, a state machine, and/or other mechanisms for electronically processing information. Although processor(s) 340 is shown in FIG. 3 as a single entity, this is for illustrative purposes only. In some implementations, processor(s) 340 may include a plurality of processing units. These processing units may be physically located within the same device, or processor(s) 340 may represent processing functionality of a plurality of devices operating in coordination. Processor(s) 340 may be configured to execute modules 308, 310, 312, 314, 316, 318, and/or 320, and/or other modules. Processor(s) 342 may be configured to execute modules 308, 310, 312, 314, 316, 318, and/or 320 and/or other modules by software; hardware; firmware; some combination of software, hardware, and/or firmware; and/or other mechanisms for configuring processing capabilities on processor(s) 340. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, and/or 320 are illustrated in FIG. 3 as being implemented within a single processing unit, in implementations in which processor(s) 340 includes multiple processing units, one or more of modules 308, 310, 312, 314, 316, 318, and/or 320 may be implemented remotely from the other modules. The description of the functionality provided by the different modules 308, 310, 312, 314, 316, 318, and/or 320 described below is for illustrative purposes, and is not intended to be limiting, as any of modules 308, 310, 312, 314, 316, 318, and/or 320 may provide more or less functionality than is described. For example, one or more of modules 308, 310, 312, 314, 316, 318, and/or 320 may be eliminated, and some or all of its functionality may be provided by other ones of modules 308, 310, 312, 314, 316, 318, and/or 320. As another example, processor(s) 340 may be configured to execute one or more additional modules that may perform some or all of the functionality attributed below to one of modules 308, 310, 312, 314, 316, 318, and/or 320.

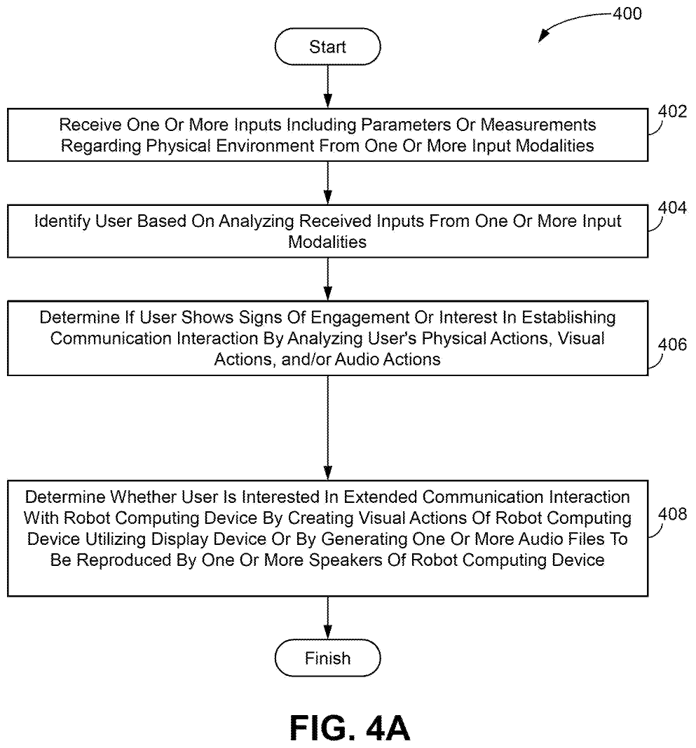

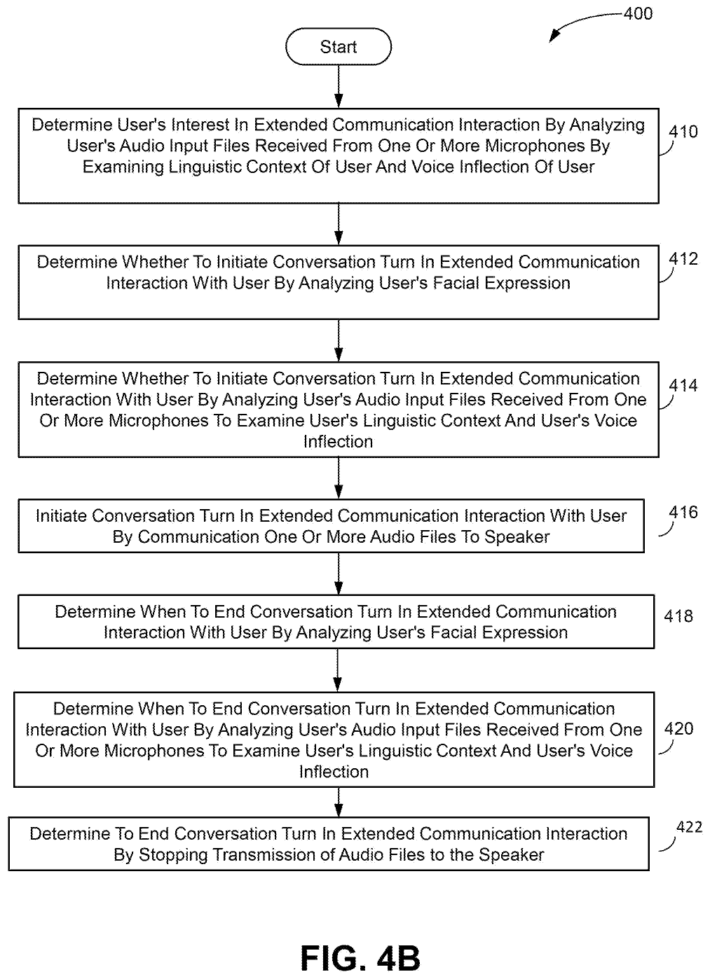

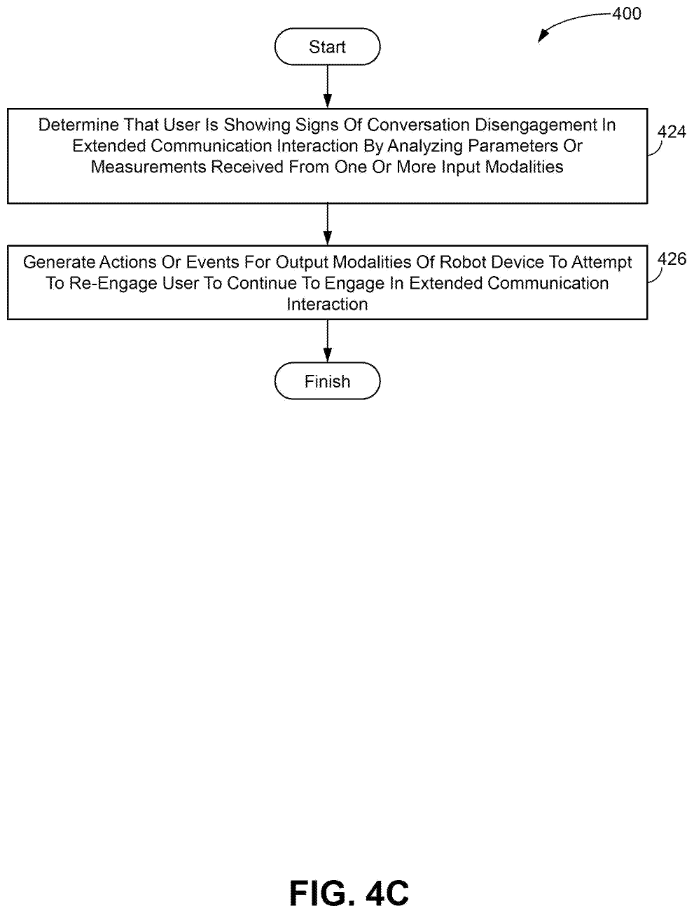

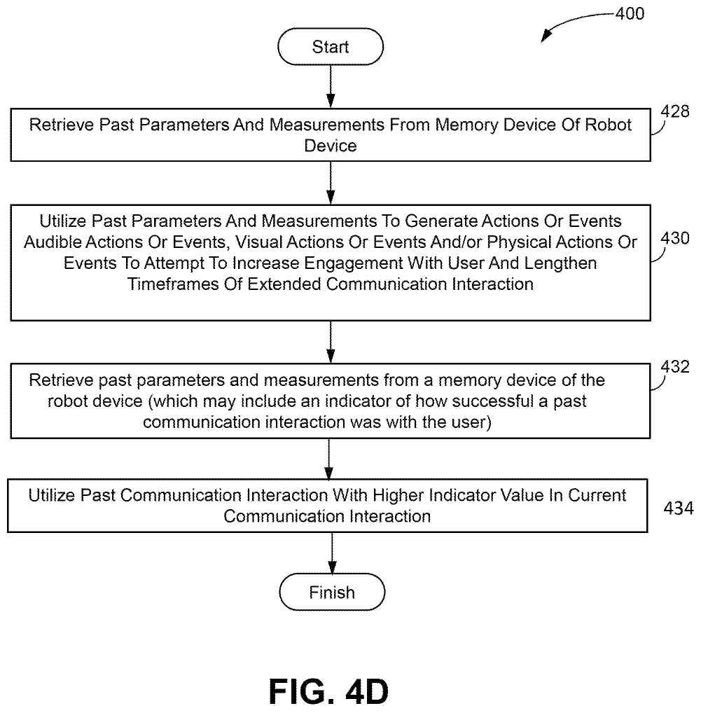

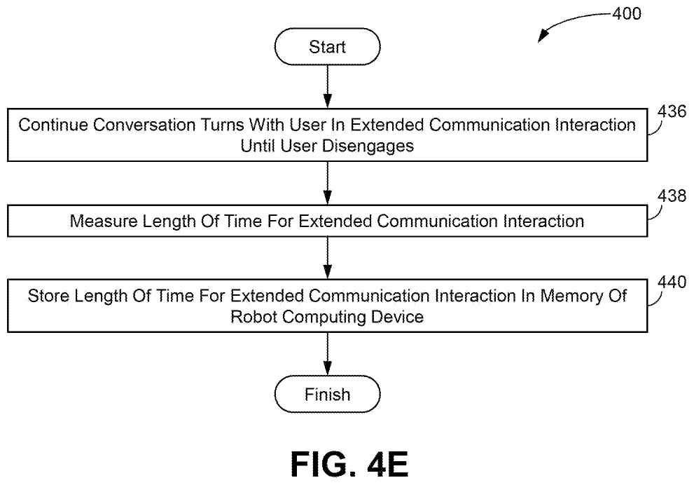

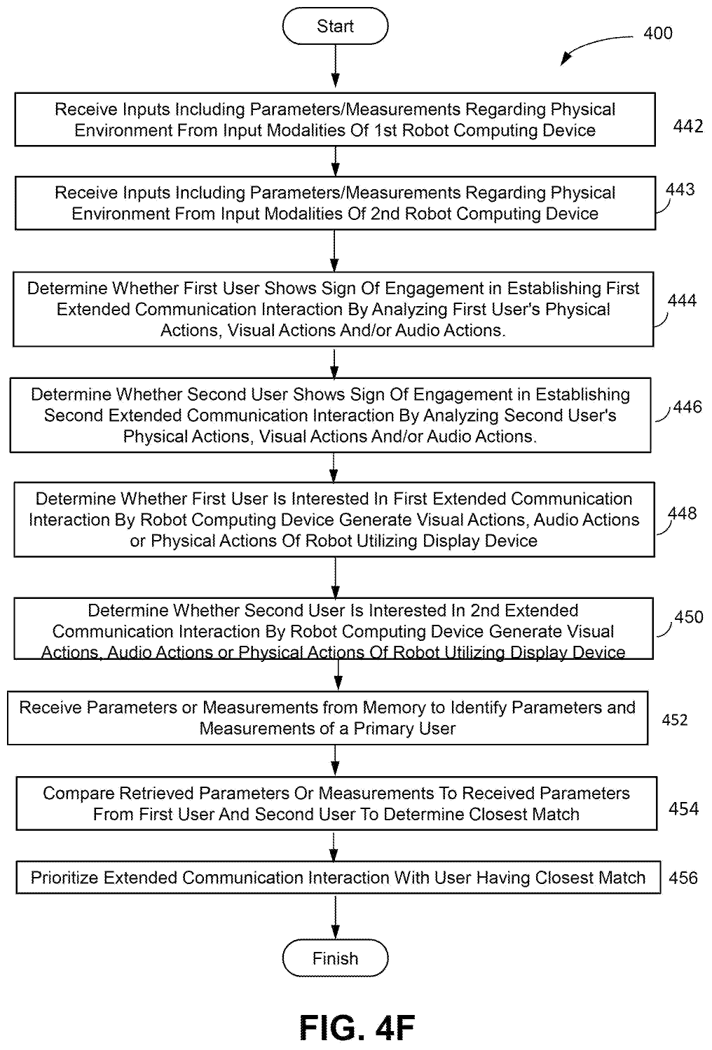

FIG. 4A illustrates a method 400 to manage communication interactions between a user and a robot computing device or digital companion, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIGS. 4A-4F and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

In some implementations, an operation 402 may include receiving one or more inputs including parameters or measurements regarding a physical environment from one or more input modalities of the robot computing device 105. In some implementations, operation 402 may be performed by one or more hardware processors configured by machine-readable instructions. In some embodiments, the input modalities may include one or more touch sensors, one or more IMU sensors, one or more cameras or imaging devices and/or one or more microphones.

In some implementations, in operation 404 may include identifying a user based on analyzing the received inputs from the one or more input modalities. Operation 404 may be performed by one or more hardware processors configured by machine-readable instructions including the software modules illustrated in FIG. 3.

In some implementations, an operation 406 may include determining if the user shows signs of engagement or interest in establishing a communication interaction with the robot computing device by analyzing a user's physical actions, visual actions, and/or audio actions. In some implementations, the robot computing device may only analyze one or two of the user's physical actions, visual actions or audio actions, but not all, in making this determination. In some implementations, different sections of the robot computing device (including hardware and/or software) may analyze and/or evaluate the user's physical actions, visual actions and/or audio actions based at least in part on the one or more inputs received from the one or more input modalities. In some implementations, operation 406 may be performed by one or more hardware processors configured by machine-readable instructions including the software modules illustrated in FIG. 3.

In some implementations, an operation 408 may include determining whether the user is interested in an extended communication interaction with the robot computing device by creating visual actions of the robot computing device utilizing the display device (e.g., opening the robot computing device's eyes or winking). In some implementations, an operation 408 may include determining whether the user is interested in an extended communication interaction with the robot computing device by generating one or more audio files to be reproduced by one or more speakers of the robot computing device (e.g., trying to attract the user's attention through verbal interactions). In some implementations both visual actions and/or audio files may be utilized to determine a user's interest in an extended communication interaction. In some embodiments, an operation 408 may include determining whether the user is interested in an extended communication interaction with the robot computing device by generating one or more mobility commands that may cause the robot computing device to move or generate commands to make portions of the robot computing device to move (which may be sent to one or more motors through motor controller(s). Operation 408 may be performed by one or more hardware processors configured by machine-readable instructions including the software modules illustrated in FIG. 3.

FIG. 4B further illustrates a method 400 to manage communication interactions between a user and a robot computing device, in accordance with one or more implementations. In some implementations, an operation 410 may include determining the user's interest in the extended communication interaction by analyzing the user's audio input files received from the one or more microphones. In some implementations, the audio input files may be examined by examining the linguistic context of the user and voice inflection of the user. In some implementations, operation 410 may be performed by one or more hardware processors configured by machine-readable instructions including the software modules illustrated in FIG. 3.

In some implementations, if the robot computing device determines a user may wish to be engaged in extended communication interactions, a conversation turn may be initiated. In some implementations, an operation 412 may include determining whether to initiate a conversation turn in the extended communication interaction with the user by analyzing the user's facial expression, the user's posture, and/or the user's gestures. In some implementations, the user's facial expression, posture and/or gestures which may be captured by the one or more imaging device(s) and/or the sensor devices of the robot computing device. In some implementations, operation 412 may be performed by one or more hardware processors configured by machine-readable instructions including a software module that is the same as or similar to conversation turn determination module 314 or other software modules illustrated in FIG. 3.

In some implementations, other inputs may be utilized by the robot computing device to initiate a conversation turn. In some implementations, an operation 414 may include determining whether to initiate a conversation turn in the extended communication interaction with the user by analyzing the user's audio input files received from the one or more microphones to examine the user's linguistic context and the user's voice inflection. In some implementations, operation 414 may be performed by one or more hardware processors configured by machine-readable instructions including a conversation turn determination module 314 or other software modules illustrated in FIG. 3. This operation may also evaluate the factors discussed in operation 412.

In some implementations, the robot computing device may decide to implement a conversation turn. In some implementations, an operation 416 may include initiating the conversation turn in the extended communication interaction with the user by communication one or more audio files to a speaker (which reproduces the one or more audio files and speaks to the user). In some implementations, operation 416 may be performed by one or more hardware processors configured by machine-readable instructions including a conversation turn initiation module 312.

In some implementations, an operation 418 may include determining when to end the conversation turn in the extended communication interaction with the user by analyzing the user's facial expression, the user's posture may and/or the user's gestures. In some implementations, the user's facial expression, posture and/or gestures may be captured by the one or more imaging device(s) and/or the sensor device(s). For example, the user may hold up their hand to stop the conversation or may turn away from the robot computing device for an extended period of time. In some implementations, operation 418 may be performed by one or more hardware processors configured by machine-readable instructions including the software modules illustrated in FIG. 3.

In some implementations, the robot computing device may also utilize other inputs in order to determine when to end a conversation turn. In some implementations, an operation 420 may include determining when to end the conversation turn in the extended communication interaction with the user by analyzing the user's audio input files received from the one or more microphones. In some implementations, the conversation agent or module may examine and/or analyze the user's audio input file to evaluate a user's linguistic context and the user's voice inflection. In some implementations, operation 420 may be performed by one or more hardware processors configured by machine-readable instructions including the software modules illustrated in FIG. 3.

In some implementations, an operation 422 may include stopping the conversation turn in the extended communication interaction by stopping transmission of audio files to the speaker, which may stop the conversation turn from the robot computing device's point of view. In some implementations, the operation 422 may be performed by one or more hardware processors configured by machine-readable instructions including a software module that is the same as or similar to conversation turn determination module 314 or other FIG. 3 modules, in accordance with one or more implementations.

The robot computing device may try to reengage the user in order to lengthen the conversation interaction. FIG. 4C illustrates a method of attempting to re-engage a user in an extended conversation according to some implementations. In some implementations, an operation 424 may include determining whether the user is showing signs of conversation disengagement in the extended communication interaction by analyzing parameters or measurements received from the one or more input modalities of the robot computing device. In some implementations, the one or more input modalities may be the one or more imaging devices, the one or more sensors (e.g., touch or IMU sensors) and/or the one or more microphones). Operation 424 may be performed by one or more hardware processors configured by machine-readable instructions including a conversation reengagement module 316.

In some implementations, an operation 426 may include generating actions or events for the one or more output modalities of the robot computing device to attempt to re-engage the user to continue to engage in the extended communication interaction. In some implementations, the one or more output modalities may include one or more monitors or displays, one or more speakers, and/or one or more motors. In some implementations, the generated actions or events include transmitting one or more audio files to the one or more speakers of robot computing device to have the robot computing device try to reengage in conversation by speaking to the user. In some implementations, the generated actions include transmitting one or more instructions or commands to the display of the robot computing device to cause the display to render facial expressions on the display to get the user's attention. In some implementations, the generated actions or events may include transmitting one or more instructions or commands to the one or more motors of the robot computing device to generate movement of the one or more appendages of the robot computing device and/or other sections of the robot computing device (e.g., the neck or the head of the device). In some implementations, operation 426 may be performed by one or more hardware processors configured by machine-readable instructions including a module that is the same as or similar to conversation reengagement module 316. The robot computing device may utilize the actions described in both steps 424 and 426 in order to obtain a more complete picture of the user's interest in reengaging in the communication interaction.

FIG. 4D illustrates methods of utilizing parameters or measurements from past communication interactions according to some implementations. In some implementations, a robot computing device may be able to utilize past conversation engagements in order to assist in improving a current conversation with a user or an upcoming conversation engagement with the user. In some implementations, an operation 428 may include retrieving past parameters and measurements from prior communication interactions from one or more memory devices of the robot computing device. In some implementations, operation 428 may be performed by one or more hardware processors configured by machine-readable instructions including the software modules described in FIG. 3. The past parameters and/or measurements may be length of conversation interactions, conversation text strings used previously, facial expressions utilized in positive communication interactions, and/or favorable or unfavorable sound files used in past conversation interactions. These are representative examples and are not limiting.

In some implementations, an operation 430 may include utilizing the retrieved past parameters and measurements of prior communication interactions to generate actions or events to engage with the user. In some implementations, the generated actions or events may be audible actions or events, visual actions or events and/or physical actions or events to attempt to increase engagement with the user and lengthen timeframes of an extended communication interaction. In some implementations, the past parameters or measurements may include topics or conversation paths previously utilized in interacting with the user. For example, in the past, the user may have liked to talk about trains and/or sports. In some implementations, operation 430 may be performed by one or more hardware processors configured by machine-readable instructions including the software modules illustrated in FIG. 3.

In some implementations, there may be multiple past extended communication interactions that the robot computing device could utilize to assist in current communication interactions and/or in future communication interactions. In some implementations, an operation 432 may include retrieving past parameters and measurements from a memory device of the robot device. The past parameters and measurements may include an indicator of how successful a past communication interaction was with the user. In some implementations, the operation 432 may also include retrieving past parameters and measurements from past communications with other users besides the present user. These past parameters and measurements from other users may include indicators of how successful past communication actions were with other users. In some implementations, these other users may share similar characteristics with the current user. This provides the additional benefit of transferring the learnings of interacting with many users to the interaction with the current user. In some implementations, operation 432 may be performed by one or more hardware processors configured by machine-readable instructions including the software modules illustrated in FIG. 3.

In some implementations, operation 434 may include utilizing a past communication interaction with a higher indicator value in a current communication interaction in order to use data from the past to improve a current or future communication interaction with a user. In some implementations, operation 434 may be performed by one or more hardware processors configured by machine-readable instructions including a software module.

FIG. 4E illustrates a method of measuring effectiveness of extended communication interaction according to some implementations. In some embodiments, an effectiveness of an extended communication interaction may be measured by how many conversation turns the user engages in with the robot computing device. Alternatively, or in addition to, an effectiveness of an extended communication interaction may be measured by how many minutes the user is engaged with the robot computing device. In some implementations, an operation 436 may include continuing conversation turns with the user in the extended communication interaction until the user disengages. In some implementations, this means keeping the extended communication interaction ongoing until a user decides to disengage. In some implementations, operation 436 may be performed by one or more hardware processors configured by machine-readable instructions including the software modules illustrated in FIG. 3.

In some implementations, after a user disengages, an operation 438 may include measuring a length of time for the extended communication interaction. In some embodiments, operation 438 may include measuring a number of conversation turns for the extended communication interaction. In some implementations, the conversation agent in the robot computing device may measure and/or capture a user's behavior and engagement level over time with one or more imaging devices (cameras), one or more microphones, and/or meta-analysis (e.g., measuring the turns of the conversation interaction and/or the language used, etc.) In some implementations, an operation 438 may be performed by one or more hardware processors configured by machine-readable instructions including the software modules illustrated in FIG. 3.

In some implementations, an operation 440 may include storing the length of time and/or a number of conversation turns for the extended communication interaction in a memory of the robot computing device so that this can be compared to previous extended communication interactions and/or to be utilized with respect to future extended communication interactions. In some implementations, operation 440 may be performed by one or more hardware processors configured by machine-readable instructions including the software modules illustrated in FIG. 3.

FIG. 4F illustrates a robot computing device evaluating parameters and measurements from two users according to some implementations. In some embodiments, methods may be utilized to determine which of a plurality of users the robot computing device should engage in communication interactions with. In some implementations, an operation 442 may include receiving one or more inputs including parameters or measurements regarding a physical environment from one or more input modalities of a first robot computing device. These parameters or measurements may include locations of robot computing device, positions of a robot computing device, and/or facial expressions of a robot computing device. In some implementations, an operation 442 may be performed by one or more hardware processors configured by machine-readable instructions including the software modules illustrated in FIG. 3.

In some implementations, an operation 443 may include receiving one or more inputs including parameters or measurements regarding a physical environment from one or more input modalities of a second robot computing device. In some implementations, an operation 442 may be performed by one or more hardware processors configured by machine-readable instructions including the software modules illustrated in FIG. 3. In some implementations, the one or more input modalities may include one or more sensors, one or more microphones, and/or one or more imaging devices.

In some implementations, an operation 444 may include determining whether a first user shows sign of engagement or interest in establishing a first extended communication interaction by analyzing a first user's physical actions, visual actions and/or audio actions. In some implementations, the first user's physical actions, visual actions and/or audio actions may be determined based at least in part on the one or more inputs received from the one or more input modalities describe above. In some implementations, the robot computing device may be analyzing whether a user is maintaining eye gaze, waving his hands or is turning away when speaking (which may indicate a user does not want to engage in conversations or communication interactions). In some embodiments, if a user's tone is friendly, the speech is directed to the robot computing device and/or a user is staring at the display (and thus eyes) of the robot computing device, this may indicate a user wants to engage in conversations or communication interactions. In some implementations, operation 444 may be performed by one or more hardware processors configured by machine-readable instructions including the software modules illustrated in FIG. 3.

In some implementations, an operation 446 may include determining whether a second user shows sign of engagement or interest in establishing a second extended communication interaction by analyzing a second user's physical actions, visual actions and/or audio actions in a similar manner to the first user. In some implementations, the second user's physical actions, visual actions and/or audio actions may be analyzed based at least in part on the one or more inputs received from the one or more input modalities. In some implementations, operation 446 may be performed by one or more hardware processors configured by machine-readable instructions including the software modules illustrated in FIG. 3.

In some implementations, the robot computing device may perform visual, physical and/or audible actions in order to try to attempt to engage the user. In some implementations, an operation 448 may determine whether the first user is interested in the first extended communication interaction with the robot computing device by having the robot computing device create visual actions of the robot utilizing the display device, generate audio actions by may communicate one or more audio files to the one or more speakers for audio playback, and/or create physical actions by communicating instructions or commands to one or more motors to move an appendage or another section of the robot computing device. In some implementations, an operation 448 may be performed by one or more hardware processors configured by machine-readable instructions including the software modules illustrated in FIG. 3.

In some implementations, an operation 450 may determine whether the second user is interested in the second extended communication interaction with the robot computing device by having the robot computing device create visual actions of the robot utilizing the display device, generate audio actions by may communicate one or more audio files to the one or more speakers for audio playback, and/or create physical actions by communicating instructions or commands to one or more motors to move an appendage or another section of the robot computing device. In some implementations, an operation 450 may be performed by one or more hardware processors configured by machine-readable instructions including the software modules illustrated in FIG. 3. In some implementations, the robot computing device may then select which of the first user and/or the second user is most interested in engaging in an extended communication interaction by comparing the results of the analyzations performed in steps 444, 446, 448 and/or 450. Although two users are described herein, the techniques described above may be utilized with three or more users and their interactions with the robot computing device.

In other implementations, it may be important to identify the primary user in a group of potential users in an environment around the robot computing device. In some implementations, a robot computing device may be able to distinguish between users and determine which user is the primary user. There may be different ways to determine which user is the primary user. In some implementations, an operation 452 may include retrieving parameters or measurements from a memory of the robot computing device to identify parameters or measurements of a primary user. In some implementations, these may be captured facial recognition parameters and/or datapoints captured by the user during setup and/or initialization of the robot computing device that can be utilized to identify that the current user is the primary user. In some implementations, operation 448 may be performed by one or more hardware processors configured by machine-readable instructions including the software modules illustrated in FIG. 3.

In some implementations, other parameters may be utilized besides facial recognition. In some implementations, an operation 454 may include comparing the retrieved parameters or measurements of the primary user to the received parameters from the first user and the received parameters from the second user in order to find or determine a closest match. In some implementations, an operation 450 may be performed by one or more hardware processors configured by machine-readable instructions including the software modules illustrated in FIG. 3.

In some implementations, an operation 456 may include prioritizing the extended communication interaction with the user having the closest match and identifying this user as the primary user. In this implementation, the robot computing device may then initiate a conversation interaction with the primary user. In some implementations, an operation 452 may be performed by one or more hardware processors configured by machine-readable instructions including the software modules illustrated in FIG. 3.

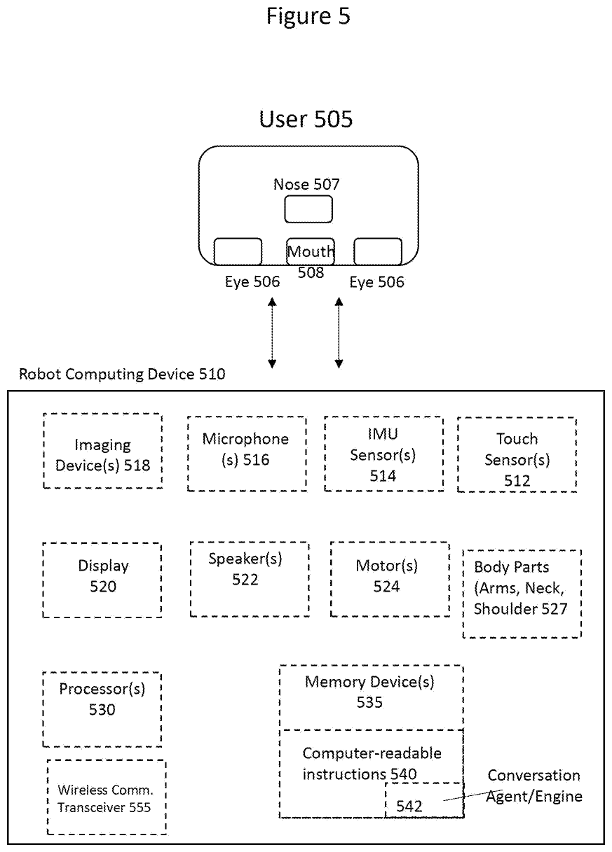

FIG. 5 illustrates communication between a user or a consumer and a robot computing device (or digital companion) according to some embodiments. In some embodiments, a user 505 may communicate with the robot computing device 510 and the robot computing device 510 communicating with the user 505. In some embodiments, multiple users may communicate with robot computing device 510 at one time, but for simplicity only one user is shown in FIG. 5. In some embodiments, the robot computing device 510 may communicate with a plurality of users and may have different conversation interactions with each user, where the conversation interaction is dependent upon the user. In some embodiments, the user 505 may have a nose 507, one or more eyes 506 and/or a mouth 508. In some embodiments, the user may speak utilizing the mouth 508 and make facial expressions utilizing the nose 507, the one or more eyes 506 and/or the mouth 508. In some embodiments, the user 505 may speak and make audible sounds via the user's mouth. In some embodiments, the robot computing device 510 may include one or more imaging devices (cameras, 3D imaging devices, etc.) 518, one or more microphones 516, one or more inertial motion sensors 514, one or more touch sensors 512, one or more displays 520, one or more speakers 522, one or more wireless communication transceivers 555, one or more motors 524, one or more processors 530, one or more memory devices 535, and/or computer-readable instructions 540. In some embodiments, the computer-readable instructions 540 may include a conversation agent module 542 which may handle and be responsible for conversational activities and communications with the user. In some embodiments, the one or more wireless communication transceivers 555 of the robot computing device 510 may communicate with other robot computing devices, a mobile communication device running a parent software application and/or various cloud-based computing devices. There are other modules that are part of the computer-readable instructions. In some embodiments, the computer-readable instructions may be stored in the one or more memory devices 535 and may be executable by the one or more processors 530 in order to perform the functions of the conversation agent module 542 as well as other functions of the robot computing device 510. The features and functions described in FIGS. 1 and 1A also apply to FIG. 5, but are not repeated here.

In some embodiments, the imaging device(s) 518 may capture images of the environment around the robot computing device 510 including images of the user and/or facial expressions of the user 505. In some embodiments, the imaging device(s) 518 may capture three-dimensional (3D) information of the user(s) (facial features, expressions, relative locations, etc.) and/or of the environment. In some embodiments, the microphones 516 may capture sounds from the one or more users. In some embodiments, the microphones 516 may capture a spatial location of the user(s) based on the sounds captured from the one or more users. In some embodiments, the inertial motion unit (IMU) sensors 514 may capture measurements and/or parameters of movements of the robot computing device 510. In some embodiments, the one or more touch sensors 512 may capture measurements when a user touches the robot computing device 510 and/or the display 520 may display facial expressions and/or visual effects for the robot computing device 510. In some embodiments, one or more secondary displays 520 may convey additional information to the user(s). In some embodiments, the secondary displays 520 may include light bars and/or one or more light-emitting diodes (LEDs). In some embodiments, the one or more speaker(s) 522 may play or reproduce audio files and play the sounds (which may include the robot computing device speaking and/or playing music for the users). In some embodiments, the one or more motors 524 may receive instructions, commands or messages from the one or more processors 530 to move body parts or sections of the robot computing device 510 (including, but not limited to the arms, neck, shoulder or other appendages.). In some embodiments, the one or more motors 524 may receive messages, instructions and/or commands via one or more motor controllers. In some embodiments, the motors 524 and/or motor controllers may allow the robot computing device 510 to move around an environment and/or to different rooms and/or geographic areas. In these embodiments, the robot computing device may navigate around the house.

In some embodiments, a robot computing device 510 may be monitoring an environment including one or more potential consumers or users by utilizing its one or more input modalities. In this embodiment, for example, the robot computing device input modalities may be one or more microphones 516, one or more imaging devices 518 and/or cameras, and one or more sensors 514 or 512 or sensor devices. For example, in this embodiment, the robot computing device's camera 518 may identify that a user may be in an environment around the area and may capture an image or video of the user and/or the robot computing device's microphones 516 may capture sounds spoken by a user. In some embodiments, the robot computing device may receive the captured sound files and/or image files, and may compare these received sound files and/or image files to existing sound files and/or image files stored in the robot computing device to determine if the user(s) can be identified by the robot computing device 510. If the user 505 has been identified by the robot computing device, the robot computing device may utilize the multimodal perceptual system (or input modalities) to analyze whether or not the user/consumer 505 shows signs of interest in communicating with the robot computing device 510. In some embodiments, for example, the robot computing device may receive input from the one or more microphones, the one or more imaging device and/or sensors and may analyze the user's location, physical actions, visual actions and/or audio actions. In this embodiment, for example, the user may speak and generate audio files (e.g., “what is that robot computing device doing here”) and may analyze images of the user's gestures (e.g., see that the user is pointing at the robot computing device or gesturing in a friendly manner towards the robot computing device 510). Both of these user actions would indicate that the user is interested in establishing communications with the robot computing device 510.

In some embodiments, in order to further verify the user wants to continue to engage in a conversation interaction, the robot computing device 510 may generate facial expressions, physical actions and/or audio responses to test engagement interest and may capture a user's responses to these generated facial expression(s), physical action(s) and/or audio responses via the multimodal input devices such as the camera 518, sensors 514 512 and/or microphones 516. In some embodiments, the robot computing device may analyze to the captured user's responses to the robot computing device's visual actions, audio files, or physical actions. For example, the robot computing device software may generate instructions, when executed, cause the robot computing device 510 to wave one of its hands or arms 527, generate a smile on lips and large open eyes on the robot computing device display 520 or flash a series of one or more lights on the one or more secondary displays 520, and send a “Would you like to play” audio file to the one or more speakers 522 to be played to the user. In response, the user may respond by nodding their head up and down and/or by saying yes (though the user's mouth 508), which may be captured by the one or more microphones 516 and/or the one or more cameras 518 and the robot computing device software 540 and/or 542 may analyze this and determine that the user would like to engage in an extended communication interaction with the robot computing device 510. In another example, if the user responds with “no” or by having their arms crossed, the microphones 516 may capture the “no” and the imaging device 518 may capture the folded arms and the conversation agent software 542 may determine the user is not interested in an extended conversation interaction.

The goal of the robot computing device and/or its conversation agent software is to engage in multi-turn communications with the user in order to enhance the conversation interaction with the user. Prior art devices were not generally good at communicating with users for multiple turns. As one example, in some embodiments, the conversation agent or module 542 may utilize a number of tools to enhance the ability to engage in multi-turn communications with the user. In some embodiments, the conversation agent or module 542 may utilize audio input files generated from the audio or speech of the user that is captured by the one or more microphones 516 of the robot computing device 510. In some embodiments, the robot computing device 510 (e.g., the conversation agent 542) may analyze the one or more audio input files by examining the linguistic context of the user's audio files and/or the voice inflection in the user's audio files. As an example, the user may state “I am bored here” or “I am hungry” and the conversation agent, module or may analyze linguistic context and determine the user is not interested in continuing conversation interaction (whereas “talking to Moxie is fun” would be analyzed and interpreted as the user being interested in continuing the conversation interaction with the robot computing device 510). Similarly, if the conversation agent or module 542 indicates the voice inflection is loud or happy, this may indicate a user's willingness to continue to engage in a conversation interaction, while a distant or sad voice inflection may identify that the user is no longer wanting to continue in the conversation interaction with the robot computing device. This technique may be utilized to determine whether the user would like to initially engage in a conversation interaction with the robot computing device and/or may also be used to determine if the user wants to continue to participate in an existing conversation interaction.

In some embodiments, the conversation agent or module 542 may analyze a user's facial expressions to determine whether to initiate another conversation turn in the conversation interaction. In some embodiments, the robot computing device may utilize the one or more cameras or imaging devices to capture the user's facial expressions and the conversation agent or module 542 may analyze the captured facial expression to determine whether or not to continue to engage in the conversation interaction with the user. In this embodiment, for example, the conversation agent or module 542 may identify that the user's facial expression is a smile and/or the eyes are wide and the pupil's focused and may determine a conversation turn should be initiated because the user is interested continuing the conversation interaction. In contrast, if the conversation agent or module 542 may identify that the user's facial expression includes a scowl, a portion of the face is turned away from the camera 518, or the eyebrows are furrowed, the conversation agent or module 542 may determine that the user may no longer wish to engage in the conversation interaction. This may also be used to determine if the user wants to continue to participate in or continue in the conversation interaction. The determination of the engagement of the user might be used by the conversation agent 542 to continue or change the topic of conversation.

In some embodiments, if the conversation agent or module 542 determines to continue with the conversation interaction, the conversation agent or module 542 may communicate one or more audio files to the one or more speakers 522 for playback to the user, may communicate physical action instructions to the robot computing device (e.g., to move body parts such as a shoulder, neck, arm and/or hand), and/or communicate facial expression instructions to the robot computing device to display specific facial expressions. In some embodiments, the conversation agent or module 542 may communicate video files or animation files to the robot computing device to be shown on the robot computing device display 520. The conversation agent or module 542 may be sending out these communications in order to capture and then analyze the user's responses to the communications. In some embodiments, if the conversation agent determines not to continue with the conversation interaction, the conversation agent may stop transmission of one or more audio files to the speaker of the robot computing device which may stop the communication interaction. As an example, the conversation agent or module 542 may communicate audio files that state “what else would you like to talk about next” or to communicate commands to the robot communication to show a video about airplanes and then ask the user “would you like to watch another video or talk about airplanes.” Based on the user's responses to these robot computing device actions, the conversation agent or module 542 may make a determination as to whether the user wants to continue to engage in the conversation interaction. For example, the robot computing device may capture the user stating “yes, more videos please” or “I would like to talk about my vacation” would be analyzed by the robot computing device conversation module wanting to continue to engage in conversation interaction, whereas the capturing of an image of a user shaking their head side-to-side or receiving an indication from a sensor that the user is pushing the robot computing device away would be analyzed by the robot computing device conversation module 542 as the user not wanting to continue to engage in the conversation interaction.

In some embodiments, the conversation agent 542 may attempt to reengage the user even if the conversation agent has determined the user is showing signs that the user does not want to continue to engage in the conversation interaction. In this embodiment, the conversation agent 542 may generate instructions or commands to cause one of the robot computing device's output modalities (e.g., the one or more speakers 522, the one or more arms 527, and/or the display 520) to attempt to reengage the user. In this embodiment, for example, the conversation agent 542 may send one or more audio files that are played on the speaker requesting the user to continue to engage (“Hi Steve, its your turn to talk;” “How are you feeling today—would you like to tell me?”). In this embodiment, for example, the conversation agent 542 may send instructions or commands to the robot computing device's motors to cause the robot computing device's arms to move (e.g., wave or go up and down) or the head to move in a certain direction to get the user's attention). In this embodiment, for example, the conversation agent 542 may instructions or commands to the robot computing device's display 520 to cause the display's eyes to blink, to cause the mouth to open in surprise or to cause the lips to mimic or lip sync the words being played by the one or more audio files, and pulse the corresponding lights in the secondary displays 520 to complete conveying the conversation state to the user.

In some embodiments, the conversation agent 542 may utilize past conversation interactions to attempt to increase a length or number of turns for a conversation interaction. In this embodiment, the conversation agent 542 may retrieve and/or utilize past conversation interaction parameters and/or measurements from the one or more memory devices 535 of the robot computing device 510 in order to enhance current conversation interactions. In this embodiment, the retrieved interaction parameters and/or measurements may also include a success parameter or indicator identifying how successful the past interaction parameters and/or measurements were increasing the number of turns and/or length of the conversation interaction between the robot computing device and/or the user(s). In some embodiments, the conversation agent 542 may utilize the past parameters and/or measurements to generate actions or events (e.g., audio actions or events; visual actions or vents; physical actions or events) to increase conversation interaction engagement with the user and/or lengthen timeframes of the conversation interactions. In this embodiment, for example, the conversation agent may retrieve past parameters identifying that if the robot computing device smiles and directs the conversation to discuss what the user had for lunch today, the user may continue with and/or extend the conversation interaction. Similarly, in this embodiment, for example, the conversation agent 542 may retrieve past parameters or measurements identifying that if the robot computing device waves it hands, lowers its speaker volume (e.g., talks in a softer voice), and/or makes its eyes larger, the user may continue with and/or extend the conversation interaction. In these cases, the conversation agent 542 may then generate output actions for the display 520, the one or more speakers 522, and/or the motors 524 based, at least in part, on the retrieved past parameters and/or measurements. In some embodiments, the conversation agent 542 may retrieve multiple past conversation interaction parameters and/or measurements and may select the conversation interaction parameters with a highest success indicator and perform the output actions identified therein. In some embodiments, the conversation agent 542 and/or modules therein, may analyze current and/or past interactions to infer a possible or potential state of mind of a user and then generate a conversation interaction that is responsive to the inferred state of mind. As an illustrative example, the conversation agent 542 may look at the current and past conversation interactions and determine that a user is agitated, and the conversation agent 542 may respond with a conversation interaction to relax the user and/or to communicate instructions for the one or more speakers to play soothing music. In some embodiments, the conversation agent 542 may also generate conversation interactions based on a time of day. As an illustrative example, the conversation agent 542 may generate conversation interaction files to increase a user's energy or activity in a morning and to generate fewer or more relaxing conversation interaction files to minimize a user's activity in order to relax into sleep in the night.

The conversation agent may also generate parameters and/or measurements for the current conversation interaction in order to be utilized in conversation analytics and/or to improve future conversations with the same user and/or other users. In this embodiment, the conversation agent may store output actions generated for the current conversation interaction in the one or more memory devices. In some embodiments, during the conversation interaction, the conversation agent 542 may also keep track of a length of the conversation interaction. After the multi-turn conversation interaction has ended between the robot device and user 505, the conversation agent 542 may store the length of the multi-turn conversation interaction in the one or more memory devices 535. In some embodiments, the conversation agent or engine may utilize conversation interaction parameters and/or content that is collected from one user to learn or teach a conversation interaction model that may be applied to other users. For example, past conversation interactions with the current user and/or with other users from a current robot computing device and/or other robot computing devices may be utilized by the conversation agent 542 to shape the content of a current conversation interaction with the user.

The conversation agent 542 also has the ability to communicate with more than one user and determine which of the more than one user is the user most likely to engage in an extended conversation interaction with the robot computing device. In some embodiments, the conversation agent 542 may cause the imaging devices 518 to capture images of users in the environment in which the robot computing device 510 is located. In some embodiments, the conversation agent 542 may compare the captured images of the users to a primary user's image that is stored in the one or more memory devices 535 of the robot computing device 510. In this embodiment, the conversation agent 542 may identify which of the captured images is closest to the primary user's image. In this embodiment, the conversation agent 542 may prioritize a conversation interaction (e.g., initiating a conversation interaction) with the user corresponding to the captured image that matches or is a closest match to the primary user). This feature allows the conversation agent 542 to communicate with the primary user first.

While the stored image may be utilized to identify a primary user, there are other methods of identifying a primary user of the robot computing device 510. In some embodiments, the conversation agent 542 of the robot computing device 510 may receive inputs including parameters and/or measurements for more than one user and may compare these received parameters and/or measurements to the primary user's parameters and/or measurements (which are stored in the one or more memory devices 535) of the robot computing device 510. In this embodiment, the conversation agent may identify, as the primary user, the user that has the closest matching received parameters and/or measurements to the stored primary user's parameters and/or measurements. In this embodiment, the conversation agent 542 may then initiate a conversation interaction with the identified user. For example, these parameters and/or measurements may be voice characteristics (pitch, timber, rate, etc.), size of different parts of the user in the captured image (e.g., size of head, size of arms, etc.), and/or other user characteristics (e.g., vocabulary level, accent, subjects discussed, etc.).

The conversation agent may also analyze which of the more than one users show the most interest in engagement by analyzing each of the more than one user's captured physical actions, visual actions and/or audio actions and comparing these. In other words, the conversation agent 542 of the robot computing device utilizes the robot computing device input modalities (e.g., the one or more microphones 516, the one or more sensors 512 and 514 and/or the one or more imaging devices 518) and captures each users' physical actions, visual actions and/or audio actions. The robot computing device captures and receives each users' physical actions, visual actions and/or audio actions (via audio files or voice files and image files or video files) and analyzes these audio files/voice files and image files/video files to determine which of the more than one users shows the most signs of conversation engagement. In this embodiment, the conversation agent 542 may communicate with the user that it has determined shows the most or highest sign of conversation engagement. For example, the robot computing device 510 may capture and the conversation agent 542 may identify that the first user has grin on their face, is trying to touch the robot in a friendly way and said “I wonder if this robot will talk me” and the second user may have their eyes focused to the side, may have his or her hands up in a defensive manner and may not be speaking. Based on the captured user actions, the conversation agent 542 may identify that the first user shows more signs of potential engagement and thus may initiate a conversation interaction with the first user.

In some embodiments, the conversation agent 542 may also cause the robot computing device 510 to perform certain actions and then capture responses received by the one or more users in order to determine which of the one or more users is interested in an extended conversation interaction. More specifically, the conversation agent 542 may cause the robot computing device 510 to generate visual actions, physical actions and/or audio actions in order to evoke or attempt to cause a user to respond to the robot computing device 510. In this embodiment, the robot computing device 510 may capture visual, audio and/or physical responses of the one or more users and then the conversation agent 542 may analyze the captured visual, audio and/or physical responses for each user to determine which of the users are most likely to engage in an extended conversation interaction. In response to this determination, the conversation agent 542 of the robot computing device 510 may then establish a communication interaction with the user most likely to engage in the extended conversation interaction. As an example of this, the conversation agent 542 may cause the robot computing device 510 to generate a smile and focus a pupil of an eye straight forward, to move both of the robot's hands in a hugging motion, and to speak the phrase “Would you like to hug me or touch my hand,” In this embodiment, the conversation agent 542 of the robot computing device 500 may capture the following responses via the one or more touch sensors 512, the one or more cameras 518 and/or the one or more microphones 516: a first user may pull hard on the robot's hand and thus the touch sensor 512 may capture a high force; may capture the user shaking their head from side to side and having their eyes closed. In this case, the conversation agent 542 may analyze these response actions and determine that this first user is not very interested in an extended conversation interaction. In contrast, the conversation agent 542 of the robot computing device 510 may capture the following responses via the touch sensors 512, the one or more cameras 518 and/or the one or more microphones 516: a second user may gently touch the hands of the robot computing device and the touch sensors 512 may capture a lighter force against the touch sensor 512 and the one or more microphones 516 may capture a sound file of the user stating the words “yes I would like to touch your hand” and the captured image from the camera 518 may indicate the user is moving closer to the robot computing device 510. Based on these second user actions, the conversation agent 542 may analyze these actions and determine that the second user is very interested in an extended conversation action with the robot computing device. Accordingly, based on the conversation agent's analysis of the first and second user responses and/or actions, the conversation agent 542 may determine to initiate and/or prioritize a conversation interaction with the second user.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination. As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method to manage verbal communication interactions between a user and a robot computing device comprising:
accessing computer-readable instructions from one or more memory devices for execution by one or more processors of the robot computing device;
executing the computer-readable instructions accessed from the one or more memory devices by the one or more processors of the robot computing device; and
wherein executing the computer-readable instructions further comprising:
receiving one or more inputs including parameters or measurements regarding a physical environment from one or more input modalities;
identifying a user based on analyzing the received inputs from the one or more input modalities;
determining if the user shows signs of engagement or interest in establishing a verbal communication interaction by analyzing a user's physical actions, visual actions, and/or audio actions, the user's physical actions, visual actions and/or audio actions determined based at least in part on the one or more inputs received from the one or more input modalities;
determining whether the user is interested in an extended verbal communication interaction with the robot computing device by creating visual actions of the robot computing device utilizing the display device or by generating one or more audio files to be reproduced by one or more speakers of the robot computing device; and
determining the user's interest in the extended verbal communication interaction by analyzing the user's audio input files received from the one or more microphones by examining voice inflection and linguistic context of the user.

2. The method of claim 1, wherein the one or more input modalities include one or more sensors, one or more microphones, or one or more imaging devices.

3. The method of claim 1, wherein the user's physical or visual actions being analyzed include the user's facial expression, the user's posture and/or the user's gestures, which are captured by the imaging device and/or the sensor devices.

4. (canceled)

5. The method of claim 1, wherein executing the computer-readable instructions further comprising:
determining whether to initiate a conversation turn in the extended verbal communication interaction with the user by analyzing the user's facial expression, the user's posture and/or the user's gestures, which are captured by the imaging device and/or the sensor devices; and
initiating the conversation turn in the extended verbal communication interaction with the user by communicating one or more audio files to a speaker.

6. The method of claim 1, wherein executing the computer-readable instructions further comprising:
determining whether to initiate a conversation turn in the extended verbal communication interaction with the user by analyzing the user's audio input files received from the one or more microphones to examine the user's linguistic context and/or the user's voice inflection; and
initiating the conversation turn in the extended verbal communication interaction with the user by communicating one or more audio files to a speaker.

7. The method of claim 5, wherein executing the computer-readable instructions further comprising:
determining when to end the conversation turn in the extended verbal communication interaction with the user by analyzing the user's facial expression, the user's posture and/or the user's gestures, which are captured by the imaging device and/or the sensor devices; and
stopping the conversation turn in the extended verbal communication interaction by stopping transmission of audio files to the speaker.

8. The method of claim 5, wherein executing the computer-readable instructions further comprising:
determining when to end the conversation turn in the extended verbal communication interaction with the user by analyzing the user's audio input files received from the one or more microphones to examine the user's linguistic context and the user's voice inflection; and
stopping the conversation turn in the extended verbal communication interaction by stopping transmission of audio files to the speaker.

9. The method of claim 5, wherein executing the computer-readable instructions further comprising:
determining that the user is showing signs of conversation disengagement in the extended verbal communication interaction by continuing to analyze parameters or measurements received from the one or more input modalities; and
generating actions or events for one or more output modalities of the robot computing device to attempt to re-engage the user to continue to engage in the extended verbal communication interaction.

10. The method of claim 9, wherein the one or more output modalities include one or more displays, one or more speakers, or one or more motors to move an appendage or a section of the robot body.

11. The method of claim 10, wherein the actions or events include transmitting one or more audio files to the one or more speakers of the robot computing device to generate sound to attempt to reengage the user.

12. The method of claim 10, wherein the actions or events include transmitting instructions or commands to the display of the robot computing device to create facial expressions for the robot computing device.

13. The method of claim 10, wherein the actions or events include transmitting instructions or commands to the one or more motors of the robot computing device to generate movement of the one or more appendages and/or sections of the robot computing device.

14. The method of claim 1, wherein executing the computer-readable instructions further comprising:
retrieving past parameters and measurements from one or more memory devices of the robot computing device; and
utilizing the past parameters and measurements to generate actions or events to attempt to increase engagement with the user and lengthen timeframes of the extended verbal communication interaction.

15. The method of claim 14, wherein the generated actions or events include audible actions or events, visual actions or events and/or physical actions or events.

16. The method of claim 1, wherein executing the computer-readable instructions further comprising:
retrieving past parameters and measurements from one or more memory devices of the robot computing device, the past parameters and measurements including a success indicator of how successful past communication interactions was with a user; and
utilizing the past parameters and measurements from a past communication interaction with a higher success indicator value as an example for a current verbal communication interaction.

17. The method of claim 1, wherein executing the computer-readable instructions further comprising:
continuing conversation turns with the user in the extended verbal communication interaction until the user disengages from the extended verbal communication interaction;
measuring a length of time for the extended verbal communication interaction; and
storing the length of time for the extended verbal communication interaction in one or more memory devices of the robot computing device.

18-22. (canceled)
